(19) United States
(12) Patent Application Publication
(10) Pub. No.: US 2024/0239960 A1
(43) Pub. Date: Jul. 18, 2024

(54) MULTIPLE CURE COREACTIVE COMPOSITIONS FOR ADDITIVE MANUFACTURING AND USES THEREOF

(71) Applicant: PPG Industries Ohio, Inc., Cleveland, OH (US)

(72) Inventors: Eric Epstein, Pittsburgh, PA (US); Cynthia Kutchko, Pittsburgh, PA (US); Bret Boyle, Pittsburgh, PA (US); Andrew Loughner, Pittsburgh, PA (US)

(73) Assignee: PPG Industries Ohio, Inc., Cleveland, OH (US)

(21) Appl. No.: 18/557,314

(22) PCT Filed: Mar. 22, 2022
(86) PCT No.: PCT/US2022/071246

§ 371 Date: Oct. 26, 2023

Related U.S. Application Data
(60) Provisional application No. 63/180,143, filed on Apr. 27, 2021.

(51) Int. Cl. C08G 75/045

(52) U.S. Cl. CPC C08G 75/045

(57) ABSTRACT

Multiple cure coreactive compositions for three-dimensional printing include a polythiol, a reactive polyamine, and a coreactive compound that is reactive with both the polythiol and the reactive polyamine. The reaction between the polythiol and the coreactive compound is catalyzed by the reactive polyamine and has a gel time that is faster that the gel time of the reaction between the coreactive compound and reactive polyamine. Other examples of multiple cure coreactive compositions suitable for three-dimensional printing include a composition comprising a reactive polyamine, a polyfunctional Michael acceptor, a poly epoxide and a non-reactive catalyst; and a composition comprising a reactive polyamine, a polyfunctional Michael acceptor, a polyepoxide or combination thereof, and an amine reactive compound. The multiple cure coreactive compositions can have a fast gel time at a temperature of 25° C. that can be adjusted by changing the content of the reactive polyamine in the multiple cure coreactive composition. The multiple cure coreactive compositions are useful for three-dimensional printing.

This application claims the benefit under 35 U.S.C. § 119(e) of U.S. Provisional Application No. 63/180,143 filed on Apr. 27, 2021, which is incorporated by reference in its entirety.

This invention was made with government support under Contract Number W911NF-17-2-0227 awarded by the U.S. Army Contracting Command on behalf of the U.S. Army Research Laboratory. The government has certain rights in the invention.

### FIELD

The field relates to multiple cure coreactive compositions for additive manufacturing and uses of the multiple cure coreactive compositions to fabricate parts.

### BACKGROUND

Coreactive compositions can be used to fabricate thermoset objects using additive manufacturing such as three-dimensional printing. To build an object multiple layers of a coreactive composition can be deposited adjoining previously deposited layers. To facilitate building the object it is useful that a previously deposited layer has sufficient structural integrity to maintain its intended shape and to support overlying layers.

Coreactive compositions for additive manufacturing such as three-dimensional printing that are characterized by a single curing chemistry can restrict the type of materials used and the speed at which a three-dimensional object can be fabricated. For example, fast curing chemistries can facilitate a rapid build speed, but the fast cure rate can also the limit the types of materials that can be used and can constrain the properties of the cured material. The use of slow curing chemistries can expand the use of different materials but with a reduced build rate.

### SUMMARY

According to the present invention, a multiple cure coreactive composition comprises a polythiol; a reactive polyamine; and a coreactive compound, wherein the coreactive compound is reactive with the polythiol and with the reactive polyamine.

According to the present invention, a multiple cure coreactive composition comprises a reactive polyamine; a polyfunctional Michael acceptor; a polyepoxide; and a non-reactive catalyst for catalyzing the reaction between the reactive polyamine and the polyfunctional Michael acceptor or a non-reactive catalyst for catalyzing the reaction between the polyamine and the polyepoxide.

According to the present invention, a multiple cure coreactive composition comprises a reactive polyamine; a polyfunctional Michael acceptor, a polyepoxide, or a combination thereof; and an amine-reactive compound.

According to the present invention, a cured composition is prepared from a multiple cure coreactive composition according to the present invention.

According to the present invention, an object fabricated using a multiple cure coreactive composition according to the present invention.

According to the present invention, a method of fabricating an object comprising extruding a multiple cure coreactive composition according to the present invention.

### BRIEF DESCRIPTION OF THE DRAWINGS

The drawings described herein are for illustration purposes only. The drawings are not intended to limit the scope of the present disclosure.

FIG. 1 shows the gel time of a multiple cure coreactive composition as a function of the percent hydrogen equivalents derived from a reactive polyamine in a multiple cure coreactive composition.

FIG. 2 shows the gel time of a multiple cure coreactive composition as a function of the wt % of a reactive polyamine in the Michael donor component of a multiple cure coreactive composition.

FIG. 3 shows the tensile strain for test specimens as described in Example 2.

### DETAILED DESCRIPTION

For purposes of the following detailed description, it is to be understood that embodiments provided by the present disclosure may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

A dash (“-”) that is not between two letters or symbols is used to indicate a point of bonding for a substituent or between two atoms. For example, —CONH₂ is attached through the carbon atom.

“Alkanediyl” refers to a diradical of a saturated, branched or straight-chain, acyclic hydrocarbon group, having, for example, from 1 to 18 carbon atoms (C₁₋₁₈), from 1 to 14 carbon atoms (C₁₋₁₄), from 1 to 6 carbon atoms (C₁₋₆), from 1 to 4 carbon atoms (C₁₋₄), or from 1 to 3 hydrocarbon atoms (C₁-3). It will be appreciated that a branched alkanediyl has a minimum of three carbon atoms. An alkanediyl can be C₂₋₁₄ alkanediyl, C₂₋₁₀ alkanediyl, C₂₋ₛ alkanediyl, C₂₋₆ alkanediyl, C₂₋₄ alkanediyl, or C₂₋₃ alkanediyl. Examples of alkanediyl groups include methane-diyl (—CH₂—), ethane-1,2-diyl (—CH₂CH₂—), propane-1,3-diyl and iso-propane-1,2-diyl (e.g., —CH₂CH₂CH₂— and—CH(CH₃)CH₂—), butane-1,4-diyl (—CH₂CH₂CH₂CH₂—), pentane-1,5-diyl (—CH₂CH₂CH₂CH₂CH₂—), hexane-1,6-diyl (—CH₂CH₂CH₂CH₂CH₂CH₂—), heptane-1,7-diyl, octane-1,8-diyl, nonane-1,9-diyl, decane-1,10-diyl, and dodecane-1,12-diyl.

“Alkanecycloalkane” refers to a saturated hydrocarbon group having one or more cycloalkyl and/or cycloalkanediyl groups and one or more alkyl and/or alkanediyl groups, where cycloalkyl, cycloalkanediyl, alkyl, and alkanediyl are defined herein. Each cycloalkyl and/or cycloalkanediyl group(s) can be C₃₋₆, C₅₋₆, cyclohexyl or cyclohexanediyl. Each alkyl and/or alkanediyl group(s) can be C₁₋₆, C₁₋₄, C₁₋₃, methyl, methanediyl, ethyl, or ethane-1,2-diyl. An alkanecycloalkane group can be C₄₋₁₈ alkanecycloalkane, C₄₋₁₆ alkanecycloalkane, C₄₋₁₂ alkanecycloalkane, C₄₋ₛ alkanecycloalkane, C₆₋₁₂ alkanecycloalkane, C₆₋₁₀ alkanecycloalkane, or C₆₋₉ alkanecycloalkane. Examples of alkanecycloalkane groups include 1,1,3,3-tetramethylcyclohexane and cyclohexylmethane.

“Alkanecycloalkanediyl” refers to a diradical of an alkanecycloalkane group. An alkanecycloalkanediyl group can be C₄₋₁₈ alkanecycloalkanediyl, C₄₋₁₆ alkanecycloalkanediyl, C₄₋₁₂ alkanecycloalkanediyl, C₄₋₈ alkanecycloalkanediyl, C₆₋₁₂ alkanecycloalkanediyl, C₆₋₁₀ alkanecycloalkanediyl, or C₆₋₉ alkanecycloalkanediyl. Examples of alkanecycloalkanediyl groups include 1,1,3,3-tetramethylcyclohexane-1,5-diyl and cyclohexylmethane-4,4′-diyl.

“Alkanearene” refers to a hydrocarbon group having one or more aryl and/or arenediyl groups and one or more alkyl and/or alkanediyl groups, where aryl, arenediyl, alkyl, and alkanediyl are defined here. Each aryl and/or arenediyl group(s) can be C₆₋₁₂, C₆₋₁₀, phenyl or benzenediyl. Each alkyl and/or alkanediyl group(s) can be C₁₋₆, C₁₋₄, C₁₋₃, methyl, methanediyl, ethyl, or ethane-1,2-diyl. An alkanearene group can be C₄₋₁₈ alkanearene, C₄₋₁₆ alkanearene, C₄₋₁₂ alkanearene, C₄₋ₛ alkanearene, C₆₋₁₂ alkanearene, C₆₋₁₀ alkanearene, or C₆₋₉ alkanearene. Examples of alkanearene groups include diphenyl methane.

“Alkanearenediyl” refers to a diradical of an alkanearene group. An alkanearenediyl group is C₄₋₁₈ alkanearenediyl, C₄₋₁₆ alkanearenediyl, C₄₋₁₂ alkanearenediyl, C₄₋₈ alkanearenediyl, C₆₋₁₂ alkanearenediyl, C₆₋₁₀ alkanearenediyl, or C₆₋₉ alkanearenediyl. Examples of alkanearenediyl groups include diphenyl methane-4,4′-diyl.

“Alkenyl” group refers to the structure —CR═C(R)₂ where the alkenyl group is a terminal group and is bonded to a larger molecule. In such embodiments, each R may independently comprise, for example, hydrogen and C₁₋₃ alkyl. Each R can be hydrogen and an alkenyl group can have the structure —CH═CH₂.

“Alkoxy” refers to a —OR group where R is alkyl as defined herein. Examples of alkoxy groups include methoxy, ethoxy, n-propoxy, isopropoxy, and n-butoxy. An alkoxy group can be C₁₋₈ alkoxy, C₁₋₆ alkoxy, C₁₋₄ alkoxy, or C₁₋₃ alkoxy.

“Alkyl” refers to a monoradical of a saturated, branched or straight-chain, acyclic hydrocarbon group having, for example, from 1 to 20 carbon atoms, from 1 to 10 carbon atoms, from 1 to 6 carbon atoms, from 1 to 4 carbon atoms, or from 1 to 3 carbon atoms. It will be appreciated that a branched alkyl has a minimum of three carbon atoms. An alkyl group can be C₁₋₆ alkyl, C₁₋₄ alkyl, or C₁₋₃ alkyl. Examples of alkyl groups include methyl, ethyl, n-propyl, iso-propyl, n-butyl, iso-butyl, tert-butyl, n-hexyl, n-decyl, and tetradecyl. An alkyl group is C₁₋₆ alkyl, C₁₋₄ alkyl, and C₁₋₃ alkyl.

“Arenediyl” refers to diradical monocyclic or polycyclic aromatic group. Examples of arenediyl groups include benzene-diyl and naphthalene-diyl. An arenediyl group can be C₆₋₁₂ arenediyl, C₆₋₁₀ arenediyl, C₆₋₉ arenediyl, or benzene-diyl.

“Cycloalkanediyl” refers to a diradical saturated monocyclic or polycyclic hydrocarbon group. A cycloalkanediyl group can be C₃₋₁₂ cycloalkanediyl, C₃₋₈ cycloalkanediyl, C₃₋₆ cycloalkanediyl, or C₅₋₆ cycloalkanediyl. Examples of cycloalkanediyl groups include cyclohexane-1,4-diyl, cyclohexane-1,3-diyl and cyclohexane-1,2-diyl.

“Cycloalkyl” refers to a saturated monocyclic or polycyclic hydrocarbon mono-radical group. A cycloalkyl group can be C₃₋₁₂ cycloalkyl, C₃₋₈ cycloalkyl, C₃₋₆ cycloalkyl, or C₅₋₆ cycloalkyl.

“Heteroalkanediyl” refers to an alkanediyl group in which one or more of the carbon atoms are replaced with a heteroatom, such as N, O, S, or P. In a heteroalkanediyl, the one or more heteroatoms can comprise N or O.

“Heterocycloalkanediyl” refers to a cycloalkanediyl group in which one or more of the carbon atoms are replaced with a heteroatom, such as N, O, S, or P. In a heterocycloalkanediyl, the one or more heteroatoms can comprise N or O.

“Heteroarenediyl” refers to an arenediyl group in which one or more of the carbon atoms are replaced with a heteroatom, such as N, O, S, or P. In a heteroarenediyl, the one or more heteroatoms can comprise N or O.

“Substituted” refers to a group in which one or more hydrogen atoms are each independently replaced with the same or different substituent(s). A substituent can comprises halogen, —S(O)₂OH, —S(O)₂, —SH, —SR where R is C₁₋₆ alkyl, —COOH, —NO₂, —NR₂ where each R independently comprises hydrogen and C₁₋₃ alkyl, —CN, ═O, C₁₋₆ alkyl, —CF₃, —OH, phenyl, C₂₋₆ heteroalkyl, C₅₋₆ heteroaryl, C₁₋₆ alkoxy, or —COR where R is C₁₋₆ alkyl. A substituent can be —OH, —NH₂, or C₁₋₃ alkyl.

“Formed from” or “prepared from” denotes open, e.g., comprising, claim language. As such, it is intended that a composition “formed from” or “prepared from” a list of recited components be a composition comprising at least the recited components or the reaction product of at least the recited components, and can further comprise other, non-recited components used to form or prepare the composition.

A “core” of a compound or a “backbone” of a prepolymer refers to the segment between the reactive terminal groups. For example, the backbone of a polythiol HS—R—SH will be —R—.

“Component” refers to a combination of constituents including, for example, coreactive compounds and additives. The constituents of a component are not coreactive or only minimally reactive until combined and mixed with another component to form a coreactive composition.

“Coreactive three-dimensional printing” refers to a method as disclosed herein in which a thermosetting composition is extruded through a nozzle to build successive layers to form a part.

“Coreactive composition” refers to a composition comprising at least two reactive compounds capable of reacting with each other. The reactive compounds can react in the absence of a catalyst, in the presence of a catalyst, or in the presence of an activated cure initiator. A coreactive composition can be reactive at a temperature less than 50° C. such as less than 30° C. A coreactive composition can be a thermosetting composition and when cured forms a thermoset.

The term “equivalent” refers to the number of functional reactive groups of the substance. “Equivalent weight” is effectively equal to the molecular weight of a substance, divided by the valence or number of functional reactive groups of the substance.

“Gel time” refers duration between the time coreactive compounds are mixed to form a coreactive composition to the time when the coreactive composition is no longer stirrable by hand using a wooden stick.

“Thermoset” refers to a polymeric material that does not exhibit a melt temperature or crystallization temperature.

“Thermosetting composition” refers to a composition comprising coreactive compounds that change irreversibly into an infusible, insoluble polymer network upon curing. Curing is the chemical process of converting a prepolymer and curing agents into a polymer of higher molecular weight and then into a polymer network. Curing results in chemical reactions that create extensive cross-linking between the coreactive compounds.

“Prepolymer backbone” refers to a segment between the reactive functional groups of the prepolymer. A prepolymer backbone typically includes repeating subunits. For example, the backbone of a polythiol having the structure HS—(R)ₙ—SH is —(R)ₙ—.

A coreactive composition can be considered to be fully cured when the hardness of the cured composition is within 10% of the maximum hardness.

The “cure time” of a coreactive composition refers to the duration between the time when the coreactants are mixed to form a coreactive composition to the time when the coreactive composition has a hardness that is within 10% of the maximum hardness of the cured composition.

Reference is now made to certain compounds, compositions, and methods of the present invention. The disclosed compounds, compositions, and methods are not intended to be limiting of the claims. To the contrary, the claims are intended to cover all alternatives, modifications, and equivalents.

Multiple cure coreactive compositions for additive manufacturing such as three-dimensional printing that incorporate more than one curing chemistry can facilitate a rapid build rate and expand the material selection to result in desired properties of a fabricated object.

Multiple cure coreactive compositions provided by the present disclosure cure by at least two curing chemistries. A first curing chemistry has a fast reaction rate and fast gel time at a temperature less than 30° C. to provide a material that maintains its intended shape when deposited using three-dimensional printing and can support overlying layers. A second curing chemistry has a slower cure rate and slower gel time than the first curing chemistry at temperatures less than 30° C. The first curing reaction can result in a polymeric network that provides structural integrity to a deposited layer and can facilitate the use of fast build rates. The first curing reaction controls the gel time of the multiple cure coreactive composition. The second curing reaction takes place over a longer period of time and can establish the bulk material properties of the object.

A multiple cure coreactive composition provided by the present disclosure can be characterized by at least two curing chemistries. For example, a multiple cure coreactive composition can be characterized by two, three, four or more curing chemistries.

Each of the curing chemistries can independently have a reaction rate. At least one of the reaction rates can be faster than a reaction rate of another curing chemistry. The reaction rate of reactive compounds can depend on a number of factors including, for example, the chemistry of the coreactants, the temperature of the multiple cure coreactive composition, the concentration of the coreactants, the molecular weight of the coreactive compounds, the catalyst (if used), and the viscosity of the multiple cure coreactive composition. The reaction rate of the coreactants can change during curing.

The gel time of a multiple cure coreactive composition can be used as a practical measure of the reaction rate such as the initial reaction rate. The gel time refers to the duration between the time when coreactive compounds are first combined and mixed to form a multiple cure coreactive composition to the time when the coreactive composition can no longer be stirred by hand.

The gel time can be used as a measure of the reaction rate between two coreactants. For example, the reaction rate between a first reactive compound and a second reactive compound can be defined as the gel time of the first and second reactive compounds.

A coreactive composition can be characterized by two different curing chemistries. In a coreactive composition, the first curing chemistry can have a first gel time and the second curing chemistry can have a second gel time. The first gel time can be determined by combining and mixing the two coreactive compounds representing the first curing chemistry, with or without additives, and measuring the duration to when the coreactive can no longer be stirred by hand. The second gel time can be determined in a similar manner for the two compounds representing the second curing chemistry.

The gel time can be measured at any suitable temperature. For example, the gel time can be measured at the use temperature of the coreactive composition such as the temperature at which the coreactive composition is extruded from a nozzle during a three-dimensional printing operation. For example, the gel time can be measured at a temperature less than 30° C., such as between 20° C. and 30° C., between 22° C. to 28° C., between 23° C. and 26° C., or at about 25° C.

In a multiple cure coreactive composition provided by the present disclosure the ratio of a first gel time to a second gel time can be, for example, greater than 2, greater than 4, greater than 5, greater than 6, greater than 10, greater than 15, greater than 20, or greater than 40. In a multiple cure coreactive composition provided by the present disclosure the ratio of the first gel time to the second gel time can be, for example, greater than 100, greater than 250, greater than 500, greater than 750, greater than 1000, greater than 1500, or greater than 2000.

In a multiple cure coreactive composition provided by the present disclosure the ratio of the first gel time to the second gel time can be, for example, from 2 to 50, from 6 to 60, from 8 to 30, or from 10 to 20. In a multiple cure coreactive composition provided by the present disclosure the ratio of the first gel time to the second gel time can be, for example, from 2 to 2000, from 100 to 1500, or from 250 to 1000.

Multiple cure coreactive compositions provided by the present disclosure can comprise a polythiol, a reactive polyamine, and a coreactive compound that is reactive with both the polythiol and with the reactive polyamine. The polythiol and the coreactive compound can react through a first curing chemistry and the reactive polyamine and the coreactive compound can react through a second curing chemistry. The gel time of the reaction between the polythiol and the coreactive compound can be shorter than the gel time of the reaction between the reactive polyamine and the coreactive compound.

A coreactive compound can comprise a polythiol or a combination of polythiols.

A polythiol can comprise two or more reactive thiol groups.

In a combination of polythiols the polythiols can differ, for example, with respect to the backbone chemistry, molecular weight, thiol functionality, or a combination of any of the foregoing.

Examples of suitable polythiols include dithiols.

Examples of suitable trifunctional polythiols include 1,2,3-propanetrithiol, 1,2,3-benzenetrithiol, heptane-1,3-7-trithiol, 1,3,5-triazine-2,4-6-trithiol, isocyanurate-containing trithiols, and combinations thereof, as disclosed in U.S. Application Publication No. 2010/0010133, and the polythiols described in U.S. Pat. Nos. 4,366,307; 4,609,762; and 5,225,472. Combinations of trithiol polyfunctionalizing agents may also be used.

Examples of suitable polythiols include pentaerythritol tetra(3-mercapto-propionate) (PETMP), trimethylol-propane tri(3-mercaptopropionate) (TMPMP), tris[2-(3-mercapto-propionyloxy)ethyl]isocyanurate (TEMPIC), di-pentaerythritol hexa(3-mercaptopropionate) (di-PETMP), tri(3-mercaptopropionate) pentaerythritol, triethylolethane tri-(3-mercaptopropionate), and combinations of any of the foregoing.

Other examples of polythiol polyfunctionalizing agents and polythiol monomers include pentaerythritol tetra(3-mercaptopropionate) (PETMP), pentaerythritol tetramercaptoacetate (PETMA), dipentaerythritol tetra(3-mercaptopropionate), dipentaerythritol tetramercaptoacetate, dipentaerythritol penta(3-mercaptopropionate), dipentaerythritol pentamercaptoacetate, dipentaerythritol hexa(3-mercaptopropionate), dipentaerythritol hexamercaptoacetate, ditrimethylolpropane tetra(3-mercaptopropionate), ditrimethylolpropane tetramercaptoacetate, and also alkoxylated, for example, ethoxylated and/or propoxylated, such as ethoxylated, products of these compounds. Examples include, pentaerythritol tetra(3-mercaptopropionate) (PETMP), pentaerythritol tetramercaptoacetate (PETMA), dipentaerythritol tetra(3-mercaptopropionate), dipentaerythritol tetramercaptoacetate, dipentaerythritol penta(3-mercaptopropionate), dipentaerythritol pentamercaptoacetate, dipentaerythritol hexa(3-mercaptopropionate), dipentaerythritol hexamercaptoacetate, ditrimethylolpropane tetra(3-mercaptopropionate), ditrimethylolpropane tetramercaptoacetate, particularly pentaerythritol tetra(3-mercaptopropionate) (PETMP), pentaerythritol tetramercaptoacetate (PETMA), dipentaerythritol hexa(3-mercaptopropionate), dipentaerythritol hexamercaptoacetate, ditrimethylolpropane tetra(3-mercaptopropionate), and ditrimethylolpropane tetramercaptoacetate.

Suitable polythiol polyfunctionalizing agents are commercially available, for example, from Bruno Bock Thiochemicals under the Thiocure® tradename.

A polythiol can include a prepolymer such as a polythiol prepolymer having a backbone as disclosed herein that has two or more reactive thiol groups.

A coreactive composition can comprise a reactive polyamine or a combination of reactive polyamines.

A reactive polyamine can comprise two or more reactive amine groups.

In a combination of reactive polyamines, the reactive polyamines can differ, for example, with respect to the backbone chemistry, molecular weight, thiol functionality, or a combination of any of the foregoing.

A reactive polyamine can include primary amine groups and/or secondary amine groups.

A reactive polyamine can be reactive with both the polythiol and with the coreactive compound. The reaction between the reactive polyamine and the polythiol can be characterized by a gel time that is shorter than the gel time of the reaction between the reactive polyamine and the coreactive compound.

A reactive polyamine can catalyze the reaction between the polythiol and the coreactive compound such as the reaction between the polythiol and a Michael acceptor, between the polythiol and a polyepoxide, and/or the reaction between the polythiol and a polyisocyanate.

Examples of suitable primary diamines include ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane (isophorone diamine or IPDA), 2,4- and/or 2,6-hexahydrotoluylene diamine, 2,4′-diaminodicyclohexyl methane, 4,4′-diaminodicyclohexyl methane, 3,3′-dialkyl-4,4′-diaminodicyclohexyl methanes such as 3,3′-dimethyl-4,4′-diaminodicyclohexyl methane, and 3,3′-diethyl-4,4′-diaminodicyclohexyl methane, 2,4- and/or 2,6-diaminotoluene, 3,5-diethyltoluene-2,4-diamine, 3,5-diethyltoluene-2,6-diamine, 3,5-dimethylthio-2,4-toluenediamine, 3,5-dimethylthio-2,4-toluenediamine, 2,4′- and/or 4,4′-diaminodiphenyl methane, dipropylene triamine, bis hexamethylene triamine, or combinations of any of the foregoing.

For example, a polyamine can have the structure of Formula (11):

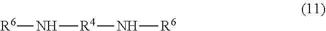

wherein,
each R⁶ is independently selected from hydrogen and C₁₋₁₀ alkyl; and
R⁴ is selected from C₁₋₂₀ alkane-diyl and C₆₋₂₀ alkanecycloalkane-diyl.

Examples of suitable secondary diamines include 4,4′-methylenebis(N-(see-butyl)cyclohexan-1-amine), N-isopropyl-3-((isopropylamino)methyl)-3,5,5-trimethylcyclohexan-1-amine, include cycloaliphatic secondary diamines available under the Jefflink® tradename from Huntsman Corporation, the Clearlink® tradename from Dorf-Ketal Chemicals, LLC, and the Desmophen® tradename from Covestro LLC, or a combination of any of the foregoing.

A reactive polyamine can be a diamine, triamine, higher polyamine and/or mixtures thereof. The monomeric amines also may be aromatic or aliphatic such as cycloaliphatics. Examples of suitable aliphatic polyamines include, ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotolulene diamine, 2,4′- and/or 4,4′-di amino-dicyclohexyl methane, 5-amino-1,3,3-trimethylcyclohexanemethylamine (isophoronediamine), 1,3-cyclohexanebis(methylamine) (1,3 BAC), and 3,3′-dialkyl-4,4′-diaminodicyclohexyl methanes (such as 3,3′-dimethyl-4,4′-diaminodicyclohexyl methane and 3,3′-diethyl-4,4′-diaminodicyclohexyl methane), 2,4- and/or 2,6-diaminotoluene and 2,4′- and/or 4,4′-diaminodiphenyl methane, or mixtures thereof.

A reactive polyamine can comprise a polyamine prepolymer such as a polyoxyalkyleneamine. Polyetheramines contain two or more primary amino groups attached to a backbone, derived, for example, from propylene oxide, ethylene oxide, or a mixture thereof. Examples of suitable polyetheramines include amine-functional polytetramethyleneglycols (PTMEG), amine-functional polypropylene glycols, amine-functional polyoxypropylene glycols such as polyoxypropylenediamines, and glycerol tris(poly(propylene glycol). Polyetheramines can have a number average molecular weight, for example, from 500 Da to 7,500 Da. Examples of suitable commercially available polyetheramines include Jeffamine® polyetheramines available from Huntsman and include polyether diamines such as Jeffamine® D-2000 and Jeffamine® D4000, polyether diamines Jeffamine® ED-600, Jeffamine® ED-900, Jeffamine® ED-2003, and polyether triamines such as Jeffamine® T-3000 and Jeffamine® T-5000.

Examples of suitable polyether amines include Jeffamine® polyetheramines from Huntsman Corp., and polyetheramines available from BASF. Examples of suitable polyetheramines include polyoxypropylenediamine.

A reactive polyamine can include a prepolymer such as a polyamine prepolymer having a backbone as disclosed herein that has two or more reactive amine groups.

A coreactive composition provided by the present disclosure can comprises a coreactive compound, or a combination of coreactive compounds.

A coreactive compound can comprise a polyfunctional Michael acceptor, a polyepoxide, or a combination thereof; or a coreactive compound can comprise a polyisocyanate. A coreactive compound can have two or more groups reactive with both a polythiol and a reactive polyamine.

The coreactive compound can react with both the polythiol and with the reactive polyamine through different chemical reactions. The reaction between the polythiol and the coreactive compound can be faster than the reaction between the reactive polyamine and the coreactive compound. Similarly, the gel time for a coreactive composition containing the polythiol and the reactive polyamine can be less than the gel time of a coreactive composition containing the reactive polyamine and the coreactive compound without the polythiol.

A coreactive compound can comprise a polyfunctional Michael acceptor or a combination of polyfunctional Michael acceptors.

A polyfunctional Michael acceptor can comprise two or more reactive Michael acceptor groups. Each of the Michael acceptor groups can be the same or at least some of the Michael acceptor groups can be different.

In a combination of polyfunctional Michael acceptors the compounds can differ, for example, with respect to the backbone chemistry, molecular weight, Michael acceptor functionality, type of Michael acceptor groups, or a combination of any of the foregoing.

A Michael acceptor group refers to an activated alkene or alkyne, such as an alkenyl group proximate to an electron-withdrawing group such as, for example, a ketone, halo, carbonyl (—CO), nitro (—NO₂), nitrile (—CN), alkoxycarbonyl (—COOR), phosphonate (—PO(OR)₂), trifluoromethyl (—CF₃), sulfonyl (—SO₂—), trifluoromethanesulfonyl (—SO₂CF₃), or p-toluenesulfonyl (—SO₂—C₆H₄—CH₃). A Michael acceptor group can be selected from a vinyl ketone, a vinyl sulfone, a quinone, an enamine, a ketimine, an aldimine, an oxazolidine, and a (meth)acryloyl. Other examples of Michael acceptors are disclosed in Mather et al., Prog. Polym. Sci., 2006, 31, 487-531, and include acrylate esters, acrylonitrile, acrylamides, maleimides, alkyl methacrylates, and cyanoacrylates. Types of compounds that function as Michael acceptors include vinyl ketones, quinones, nitroalkenes, acrylonitriles, acrylates, methacrylates, cyanoacrylates, acrylamides, maleimides, dialkyl vinylphosphonate, and vinylsulfones. Other Michael acceptors include vinyl ketones, α,β-unsaturated aldehydes, vinyl phosphonates, acrylonitrile, vinyl pyridines, certain azo compounds, β-keto acetylenes and acetylene esters.

A Michael acceptor can be a poly(meth)acrylate.

Examples of suitable difunctional methacrylates include 1,6-hexanediol diacrylate, 1,6-hexanediol diacrylate, 6-hexanediol diacrylate, hydroxypivalic acid neopentyl glycol diacrylate, neopentyl glycol diacrylate, tripropylene glycol diacrylate, dipropylene diglycol diacrylate, tricyclodecane dimethanol diacrylate, tetrapentylene glycol diacrylate, polyethylene glycol diacrylate, polyethylene glycol diacrylate, polyethylene glycol 300 diacrylate, polyethylene glycol 600 diacrylate, and polyethylene glycol 400 diacrylate. Additional examples of suitable difunctional methacrylates include 1,6-hexanediol dimethacrylate, 1,4-butanediol dimethacrylate, neopentyl glycol dimethacrylate, ethylene glycol dimethacrylate, diethylene glycol dimethacrylate, triethylene glycol dimethacrylate, bisphenol A (EO)₄ dimethacrylate, bisphenol A (EO)₃ dimethacrylate, bisphenol A (EO)₁₀ dimethacrylate, bisphenol A (EO)₃₀ dimethacrylate, 1,3-butylene glycol dimethacrylate, polyethylene glycol 400 dimethacrylate, and polyethylene glycol 200 dimethacrylate.

Examples of suitable trifunctional acrylates include trimethylolpropane triacrylate, trimethylol propane (EO)₁₅ triacrylate, glycerin triacrylate, pentaerythritol triacrylate, trimethylolpropane (PO₃) triacrylate, tris(2-hydroxyethyl)isocyanurate triacrylate.

Examples of suitable multifunctional acrylates include pentaerythritol (EO)ₙ tetraacrylate, trimethylolpropane tetraacrylate, pentaerythritol tetraacrylate, dipentaerythritol pentacrylate, and dipentaerythritol hexaacrylate.

Other suitable multifunctional (meth)acrylates include aliphatic urethane acrylates, aromatic urethane acrylates, urethane methacrylates, bisphenol A epoxy acrylate, bisphenol A methacrylates, novolac epoxy acrylates, modified epoxy acrylates, polyester acrylates, high refractive index acrylates, low refractive index acrylates, silicone acrylates, melamine acrylates, butadiene acrylates, dendritic acrylates, acrylic acrylates, and caprolactone acrylates.

Poly(meth)acrylates are available from Miwon Specialty Chemical Co. Ltd. under the tradename Miramer®.

A polyfunctional Michael acceptor can include a prepolymer such as a prepolymer having a backbone as disclosed herein that has two or more reactive Michael acceptor groups.

A coreactive compound can comprise a polyepoxide or a combination of polyepoxides.

A polyepoxide can comprise two or more reactive epoxy groups.

In a combination of polyepoxides the polyepoxides can differ, for example, with respect to the backbone chemistry, molecular weight, epoxy functionality, or a combination of any of the foregoing.

Examples of suitable diepoxides include diglycidyl ether, 1,4-butanediol diglycidyl ether, neopentyl glycol diglycidyl ether, 1,3-butanediol diglycidyl ether, Neopentyl glycol diglycidyl ether, dipropylene glycol diglycidyl ether, 1,6-hexanediol diglycidyl ether, ethylene glycol diglycidyl ether, diethylene glycol diglycidyl ether, glycerol 1,3-diglycidyl ether, etoglucid, 1,5-hexadiene diepoxide, diepoxy propyl ether, 1,5-hexadiene diepoxide, 1,2:9,10-diepoxydecane, 1,2:8,9-diepoxynonanne, and 1,2:6,7-diepoxyheptane; aromatic diepoxides such as resorcinol diglycidyl ether, bisphenol A diglycidyl ether, bisphenol F diglycidyl ether, bis[4-(glycidyloxy)phenyl]methane, 1,4-bis(glycidyloxy)benzene, tetramethylbiphenyl diglycidyl ether, and 4,4-diglyciyloxybiphenyl; and cyclic diepoxides such as 1,4-cyclohexanedimethanol diglycidyl ether, hydrogenated bisphenol A diglycidyl ether, and 1,4-bis(glycidyloxy)cyclohexane.

Examples of suitable polyepoxides include polyepoxides such as hydantoin diepoxide, diglycidyl ethers of bisphenol-A, diglycidyl ether of bisphenol-F, novolac type epoxides such as DEN™ 438 (phenol novolac polyepoxide comprising the reaction product of epichlorohydrin and phenol-formaldehyde novolac) and DEN™ 431 (phenol novolac polyepoxide comprising the reaction product of epichlorohydrin and phenol-formaldehyde novolac), available from Dow Chemical Co., certain epoxidized unsaturated, and combinations of any of the foregoing.

A polyepoxide can comprise a phenol novolac polyepoxide such as DEN®431, a bisphenol A/epichlorohydrin derived polyepoxide such as EPON® 828, or a combination thereof. A polyepoxide can comprise a combination of a phenol novolac polyepoxide and a bisphenol A/epichlorohydrin derived polyepoxide (a bisphenol A type polyepoxide).

Other examples of suitable polyepoxides include bisphenol A type polyepoxides, brominated bisphenol A type polyepoxides, bisphenol F type polyepoxides, biphenyl type polyepoxides, novolac type polyepoxides, an alicyclic polyepoxides, naphthalene type polyepoxides, ether series or polyether series polyepoxides, oxirane ring-containing polybutadienes, silicone polyepoxide copolymers, and a combination of any of the foregoing.

Additional examples of suitable bisphenol A/epichlorohydrin derived polyepoxides include a bisphenol A type polyepoxide having a weight average molecular weight of 400 or less; a branched polyfunctional bisphenol A type polyepoxide such as p-glycidyloxyphenyl dimethyltolyl bisphenol A diglycidyl ether, a bisphenol F type polyepoxide; a phenol novolac type polyepoxide having a weight average molecular weight of 570 or less, an alicyclic polyepoxide such as vinyl(3,4-cyclohexene)dioxide, methyl 3,4-epoxycyclohexylcarboxylate (3,4-epoxycyclohexyl), bis(3,4-epoxy-6-methylcyclohexylmethyl) adipate and 2-(3,4-epoxycyclohexyl)-5,1-spiro(3,4-epoxycyclohexyl)-m-dioxane, a biphenyl type epoxy such as 3,3′,5,5′-tetramethyl-4,4′-diglycidyloxybiphenyl; a glycidyl ester type epoxy such as diglycidyl hexahydrophthalate, diglycidyl 3-methylhexahydrophthalate and diglycidyl hexahydroterephthalate; a glycidylamine type polyepoxide such as diglycidylaniline, diglycidyltoluidine, triglycidyl-p-aminophenol, tetraglycidyl-m-xylene diamine, tetraglycidylbis(aminomethyl)cyclohexane; a hydantoin type polyepoxide such as 1,3-diglycidyl-5-methyl-5-ethylhydantoin; and a naphthalene ring-containing polyepoxide. Also, a polyepoxide having silicone such as 1,3-bis(3-glycidoxy-propyl)-1,1,3,3-tetramethyldisiloxane may be used. Other examples of suitable polyepoxides include (poly)ethylene glycol diglycidyl ether, (poly)propylene glycol diglycidyl ether, butanediol diglycidyl ether and neopentyl glycol diglycidyl ether; and tri-epoxides such as trimethylolpropane triglycidyl ether and glycerin triglycidyl ether.

Examples of commercially available polyepoxides suitable for use in coreactive compositions provided by the present disclosure include polyglycidyl derivatives of phenolic compounds, such as those available under the trade names Epon® 828, Epon® 1001, Epon® 1009, and Epon® 1031, from Resolution Performance Products LLC; and DER® 331, DER 332, DER® 334, and DER® 542 from Dow Chemical Co. Other suitable polyepoxides include polyepoxides prepared from polyols and polyglycidyl derivatives of phenol-formaldehyde novolacs, the latter of which are commercially available under the trade names DEN® 431, DEN® 438, and DEN® 439 from Dow Chemical Company. Cresol analogs are also available commercially ECN® 1235, ECN® 1273, and ECN® 1299 from Ciba Specialty Chemicals, Inc. SU-8 is a bisphenol A-type polyepoxide novolac available from Resolution Performance Products LLC. Polyglycidyl adducts of amines, aminoalcohols and polycarboxylic acids are also useful polyepoxides, including Glyamine® 135, Glyamine® 125, and Glyamine® 115 from F.I.C. Corporation; Araldite® MY-720, Araldite® MY-721, Araldite® 0500, and Araldite® 0510 from Ciba Specialty Chemicals.

A polyepoxide can comprise a urethane-modified diepoxide. A urethane diepoxide can be derived from the reaction of an aromatic diisocyanate and a diepoxide. A urethane-modified diepoxide can comprise a diepoxide having the structure of Formula (1):

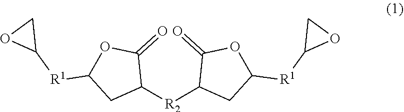

where each R¹ is derived from a diglycidyl ether and R² is derived from an aromatic diisocyanate. Diepoxides of Formula (1) are available, for example, from Kukdo Chemical Co., Ltd. (Korea).

A bisphenol A/epichlorohydrin derived polyepoxide can comprise pendent hydroxyl groups such as, for example, from 1 to 10 pendent hydroxyl groups, from 1 to 8 hydroxyl groups, from 1 to 6 hydroxyl groups, from 1 to 4 pendent hydroxyl groups, or from 1 to 2 pendent hydroxyl groups, such as 1, 2, 3, 4 5, or 6 pendent hydroxyl groups. A bisphenol A/epichlorohydrin derived polyepoxide having pendent hydroxyl groups can be referred to as hydroxyl-functional bisphenol A/epichlorohydrin derived polyepoxide. Hydroxyl-functional bisphenol A/epichlorohydrin derived polyepoxide can have an epoxy equivalent weight from 400 Daltons to 1,500 Daltons, from 400 Daltons to 1,000 Daltons or from 400 Daltons to 600 Daltons.

A bisphenol A/epichlorohydrin derived polyepoxide having hydroxyl pendent groups can have the structure of Formula (2):

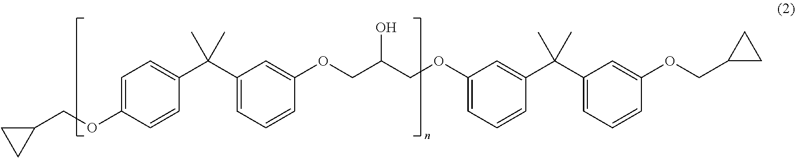

where n is an integer from 1 to 6, or n is within a range from 1 to 6. In a polyepoxide of Formula (2), n can be 2.

A polyepoxide can be a phenol novolac polyepoxide. Phenol novolac polyepoxides are multifunctional polyepoxides obtained by reacting a phenolic novolac with epichlorohydrin and contain more than two epoxy groups per molecule. Phenol novolac polyepoxides can have an EEW, for example, from 150 to 200. Phenol novolac polyepoxides can have the structure of Formula (3):

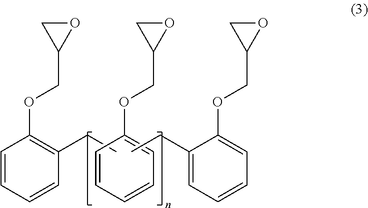

where n can have an average value, for example, from 0.2 to 1.8 (DER™ 354, DEN™ 431, DEN™ 438, and DEN™ 439, available from Dow Chemical Company).

A polyepoxide can include prepolymers terminated in two or more epoxy functional groups. A polyepoxide prepolymer can have, for example, any of the prepolymer backbones disclosed herein.

A coreactive compound can comprise a polyisocyanate or a combination of polyisocyanates.

A polyisocyanate can comprise two or more reactive isocyanate groups.

In a combination of polyisocyanates the compounds can differ, for example, with respect to the backbone chemistry, molecular weight, isocyanate functionality, or a combination of any of the foregoing.

Examples of suitable polyisocyanates include aliphatic diisocyanates, alicyclic aliphatic diisocyanates, aromatic diisocyanates, and combinations of any of the foregoing.

A diisocyanate can comprise a rigid diisocyanate, a flexible diisocyanate, or a combination thereof. The terms rigid diisocyanate and flexible diisocyanate refer to the relative conformational degrees of freedom of the molecule. A rigid or hard diisocyanate refers to a diisocyanate that has no or few conformational degrees of freedom. An example of a rigid diisocyanate is 4,4′-methylene dicyclohexyl diisocyanate (H₁₂MDI). A flexible diisocyanate has more conformational degrees of freedom than that of a rigid diisocyanate. An example of a flexible diisocyanate, compared to H₁₂MDI, is isophorone diisocyanate (IPDI). Tetramethyl xylene diisocyanate (TMXDI) is another example of a flexible diisocyanate.

Flexible diisocyanates can be characterized by diisocyanates having an at least partially linear structure. Flexible diisocyanates generally include aliphatic diisocyanates. Examples of suitable flexible aliphatic diisocyanates include 1,6-hexamethylene diisocyanate, 1,5-diisocyanato-2-methylpentane, 1,6-diisocyanato-2,2,4-trimethylhexane, 1,6-diisocyanato-2,4,4-trimethylhexane, 1,4-diisocyanatobutanone, tri-methyl-hexamethylene diisocyanate, 1,8-diisocyanatooctane, 1,12-diisocyanatododecane, 1,8-diisocyanato-2,4-dimethyloctane, and TMXDI. In TMXDI, the isocyanate is not bonded directly to the aromatic ring. Flexible diisocyanates also include diisocyanates having a single aromatic or cycloaliphatic ring such as isophorone diisocyanate (IPDI), 1,3-bis(isocyanato methyl)cyclohexane, 1,4-bis(isocyanato methyl)cyclohexane, trans-1,4-cyclohexylene diisocyanate, and 2,4-diisocyanato-1-methyl cyclohexane.

A rigid diisocyanate can include two aromatic or cycloalkane rings. Examples of rigid diisocyanates include 4,4-methylene dicyclohexyl diisocyanate and bis(4-isocyanatocyclohexyl) methane.

Suitable aliphatic diisocyanates for preparing polyurethane prepolymers provided by the present disclosure include, for example, isophorone diisocyanate (IPDI), tetramethyl xylene diisocyanate (TMXDI), 4,4′-methylene dicyclohexyl diisocyanate (H₁₂MDI), methylene diphenyl diisocyanate (MDI), toluene diisocyanate (TDI), 1,6-hexamethylene diisocyanate (HDI), pentane, 1,5-diisocyanato-, and a combination of any of the foregoing.

Examples of other suitable aliphatic diisocyanates include 1,5-diisocyanato-2-methylpentane, methyl-2,6-diisocyanatohexanoate, bis(isocyanatomethyl)cyclohexane, 1,3-bis(isocyanatomethyl)cyclohexane, 2,2,4-trimethylhexane 1,6-diisocyanate, 2,4,4-trimethylhexane 1,6-diisocyanate, 2,5(6)-bis(isocyanatomethyl)cyclo[2.2.1.]heptane, 1,3,3-trimethyl-1-(isocyanatomethyl)-5-isocyanatocyclohexane, 1,8-diisocyanato-2,4-dimethyloctane, octahydro-4,7-methano-1H-indenedimethyl diisocyanate, and 1,1′-methylenebis(4-isocyanatocyclohexane).

Examples of suitable alicyclic aliphatic diisocyanates include isophorone diisocyanate (IPDI), 1,4-cyclohexyl diisocyanate (CHDI), methylcyclohexane diisocyanate, bis(isocyanatomethyl)cyclohexane, bis(isocyanatocyclohexyl)methane, bis(isocyanatocyclohexyl)-2,2-propane, bis(isocyanatocyclohexyl)-1,2-ethane, 2-isocyanatomethyl-3-(3-isocyanatopropyl)-5-isocyanatomethyl-bicyclo[2.2.1]-heptane, 2-isocyanatomethyl-3-(3-isocyanatopropyl)-6-isocyanatomethyl-bicyclo[2.2.1]-heptane, 2-isocyanatomethyl-2-(3-isocyanatopropyl)-5-isocyanatomethyl-bicyclo[2.2.1]-heptane, 2-isocyanatomethyl-2-(3-isocyanatopropyl)-6-isocyanatomethyl-bicyclo[2.2.1]-heptane, 2-isocyanatomethyl-3-(3-isocyanatopropyl)-6-(2-isocyanatoethyl)-bicyclo[2.2.1]-heptane, 2-isocyanatomethyl-2-(3-isocyanatopropyl)-5-(2-isocyanatoethyl)-bicyclo[2.2.1]-heptane, and 2-isocyanatomethyl-2-(3-isocyanatopropyl)-6-(2-isocyanatoethyl)-bicyclo[2.2.1]-heptane.

Other examples of suitable alicyclic diisocyanates for preparing polyurethane prepolymers provided by the present disclosure include 2,2,4-trimethylhexamethylene diisocyanate (TMDI), 1,6-hexamethylene diisocyanate (HDI), 1,1′-methylene-bis-(4-isocyanatocyclohexane), 4,4′-methylene-bis-(cyclohexyl diisocyanate) (4,4-methylene dicyclohexyl diisocyanate (H₁₂MDI)), hydrogenated toluene diisocyanate, 4,4′-isopropylidene-bis-(cyclohexyl isocyanate), 1,4-cyclohexyl diisocyanate (CHDI), 4,4′-dicyclohexylmethane diisocyanate (Desmodur® W), and 3-isocyanato methyl-3,5,5-trimethylcyclohexyl diisocyanate (IPDI). Mixtures and combinations of these diisocyanates can also be employed.

Compositions prepared using acyclic and alicyclic aliphatic diisocyanates may exhibit greater stability relative to compositions prepared using other diisocyanates when exposed to ultraviolet (UV) light.

Examples of suitable aromatic diisocyanates in which the isocyanate groups are not bonded directly to the aromatic ring include bis(isocyanatoethyl)benzene, α,α,α′,α′-tetramethylxylene diisocyanate, 1,3-bis(1-isocyanato-1-methylethyl)benzene, bis(isocyanatobutyl)benzene, bis(isocyanatomethyl)naphthalene, bis(isocyanatomethyl)diphenyl ether, bis(isocyanatoethyl)phthalate, and 2,5-di(isocyanatomethyl)furan.

Suitable aromatic diisocyanates having isocyanate groups bonded directly to the aromatic ring include, for example, phenylene diisocyanate, ethylphenylene diisocyanate, isopropylphenylene diisocyanate, dimethylphenylene diisocyanate, diethylphenylene diisocyanate, diisopropylphenylene diisocyanate, naphthalene diisocyanate, methylnaphthalene diisocyanate, biphenyl diisocyanate, 4,4′-diphenylmethane diisocyanate, bis(3-methyl-4-isocyanatophenyl)methane, bis(isocyanatophenyl)ethylene, 3,3′-dimethoxy-biphenyl-4,4′-diisocyanate, diphenylether diisocyanate, bis(isocyanatophenylether)ethyleneglycol, bis(isocyanatophenylether)-1,3-propyleneglycol, benzophenone diisocyanate, carbazole diisocyanate, ethylcarbazole diisocyanate, dichlorocarbazole diisocyanate, 4,4′-diphenylmethane diisocyanate, p-phenylene diisocyanate, 2,4-toluene diisocyanate, and 2,6-toluene diisocyanate.

Other examples of suitable aromatic diisocyanates include 1,3-phenylene diisocyanate, 1,4-phenylene diisocyanate, 2,6-toluene diisocyanate (2,6-TDI), 2,4-toluene diisocyanate (2,4-TDI), a blend of 2,4-TDI and 2,6-TDI, 1,5-diisocyanato naphthalene, diphenyl oxide 4,4′-diisocyanate, 4,4′-methylenediphenyl diisocyanate (4,4-MDI), 2,4′-methylenediphenyl diisocyanate (2,4-MDI), 2,2′-diisocyanatodiphenylmethane (2,2-MDI), diphenylmethane diisocyanate (MDI), 3,3′-dimethyl-4,4′-biphenylene isocyanate, 3,3′-dimethoxy-4,4′-biphenylene diisocyanate, 1-[(2,4-diisocyanatophenyl)methyl]-3-isocyanato-2-methyl benzene, 2,4,6-triisopropyl-m-phenylene diisocyanate, and a combination of any of the foregoing.

A suitable diisocyanate can comprise a diisocyanate having the structure of Formula (4):

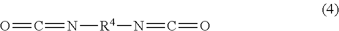

wherein R⁴ can independently be selected from C₁₋₁₀ alkane-diyl, C₅₋₈ cycloalkane-diyl, C₆₋₁₀ arenediyl, C₆₋₁₈ alkanecycloalkane-diyl, C₇₋₁₈ alkanearene-diyl, C₁₋₁₀ heteroalkane-diyl, C₅₋₈ heterocycloalkane-diyl, C₆₋₁₀ heteroarene-diyl, C₆₋₁₈ heteroalkanecycloalkane-diyl, C₇₋₁₈ heteroalkanearene-diyl, substituted C₁₋₁₀ alkane-diyl, substituted C₅₋₈ cycloalkane-diyl, substituted C₆₋₁₀ arene-diyl, substituted C₆₋₁₈ alkanecycloalkane-diyl, substituted C₇₋₁₈ alkanearene-diyl, substituted C₁₋₁₀ heteroalkane-diyl, substituted C₅₋₈ heterocycloalkane-diyl, and substituted C₆₋₁₀ heteroarene-diyl.

In diisocyanates of Formula (4), R⁴ can be selected from C₁₋₁₀ alkane-diyl, C₅₋₈ cycloalkanediyl, C₆₋₁₈ alkanecycloalkane-diyl, substituted C₁₋₁₀ alkane-diyl, substituted C₅₋₈ cycloalkanediyl, substituted C₆₋₁₈ alkanecycloalkane-diyl, and substituted C₁₋₁₀ heteroalkane-diyl.

In diisocyanates of Formula (4), R⁴ can be selected from C₁₋₁₀ alkane-diyl, C₅₋₈ cycloalkanediyl, and C₆₋₁₈ alkanecycloalkane-diyl.

In diisocyanates of Formula (4), R⁴ can be C₆₋₁₈ alkanecycloalkane-diyl.

In diisocyanates of Formula (4), R⁴ can be di(4-yl-cyclohexyl)methane.

In diisocyanates of Formula (4), R⁴ can C₁₃₋₁₈ alkanecycloalkane-diyl.

A suitable diisocyanate can comprise an aliphatic diisocyanate.

A suitable diisocyanate can comprise, for example, isophorone diisocyanate, a hexamethylene diisocyanate, diphenylmethane diisocyanate, toluene diisocyanate, dicyclohexylmethane-4,4′-diisocyanate, or a combination of any of the foregoing.

A polyisocyanate can comprise a diisocyanate trimer. A diisocyanate trimer can comprise a diisocyanate trimer having the structure of Formula (5):

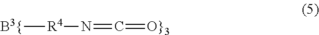

where,

each R⁴ can independently be selected from C₁₋₁₀ alkanediyl, C₅₋₈ cycloalkanediyl, C₆₋₁₀ arenediyl, C₆₋₁₈ alkanecycloalkanediyl, C₇₋₁₈ alkanearenediyl, C₁₋₁₀ heteroalkanediyl, C₅₋₈ heterocycloalkanediyl, C₆₋₁₀ heteroarenediyl, C₆₋₁₈ heteroalkanecycloalkanediyl, C₇₋₁₈ heteroalkanearenediyl, substituted C₁₋₁₀ alkanediyl, substituted C₅₋₈ cycloalkanediyl, substituted C₆₋₁₀ arenediyl, substituted C₆₋₁₀ alkanecycloalkanediyl, substituted C₇₋₁₈ alkanearenediyl, substituted C₁₋₁₀ heteroalkanediyl, substituted C₅₋₈ heterocycloalkanediyl, and substituted C₆₋₁₀ heteroarenediyl.

A polyisocyanate can include a polyisocyanate prepolymer having two or more reactive isocyanate groups. A polyisocyanate prepolymer can have a prepolymer backbone as disclosed herein.

A thiol reaction such as a thia-Michael addition reaction, a thia-epoxy reaction, and a thia-isocyanate reaction can have a gel time at a temperature less than 30° C., such as from 20° C. to 30° C., from 22° C. to 28° C. or from 23° C. to 26° C., of less than 10 minutes, less than 8 minutes, less than 6 minutes, less than 4 minutes, less than 2 minutes, less than 1 minute, or less than 30 seconds.

The reaction between the polythiol and the coreactive compound can be a nucleophilic reaction.

The reaction between the polythiol and the coreactive compound can be an amine-catalyzed reaction where the reaction is catalyzed by the reactive polyamine.

An amine reaction such as an amine-Michael addition reaction, an amine-epoxy reaction, and an amine-isocyanate reaction can have a gel time at a temperature less than 30° C., such as from 20° C. to 30° C., from 22° C. to 28° C. or from 23° C. to 26° C., greater than the gel time of the corresponding thiol reactions at the same temperature.

For example, the gel time of the amine reaction can be 2 times longer than that gel time of the thiol reaction, 4 times, 8 times, 10, times 15 times, 20 times, or 40 times longer than the gel time of the thiol reaction at the same temperature.

The reaction between the reactive polyamine and the coreactive compound can be a nucleophilic reaction.

A coreactive composition provided by the present disclosure, such as a coreactive composition in which the coreactive compound comprises a polyfunctional Michael acceptor and/or a polyepoxide, can comprise a reactive polyamine or a combination of reactive polyamines.

In a coreactive composition provided by the present disclosure, the reactive polyamine can serve both to catalyze the reaction between the polythiol and the coreactive compound and can also react with the coreactive compound and thereby form a cured thermoset having two polymeric networks.

A coreactive compound can react with the reactive polyamine and to a lesser extent, if any, with the polythiol.

A coreactive compound can comprise two or more groups reactive with amine groups.

In a combination of coreactive compounds the coreactive compounds can differ, for example, with respect to the backbone chemistry, molecular weight, functionality, type of ammine-reactive group, or a combination of any of the foregoing.

A multiple cure coreactive composition can comprise a reactive polyamine; a polyfunctional Michael acceptor; a polyepoxide; and a non-reactive catalyst for catalyzing the reaction between the reactive polyamine and the polyfunctional Michael acceptor or a non-reactive catalyst for catalyzing the reaction between the polyamine and the polyepoxide.

A reactive polyamine, a polyfunctional Michael acceptor and a polyepoxide can include any of those disclosed herein.

A non-reactive catalyst can comprise, for example, a tertiary amine and/or a Lewis base.

In a multiple cure coreactive composition provided by the present disclosure, a reaction between the reactive polyamine and the Michael acceptor is characterized by a first gel time at a temperature of 25° C.; a reaction between the reactive polyamine and polyepoxide is characterized by a second gel time at a temperature of 25° C.; and the ratio of the first gel time to the second gel time is greater than 2.

In a multiple cure coreactive composition provided by the present disclosure, a reaction between the reactive polyamine and the Michael acceptor is characterized by a first gel time at a temperature of 25° C.; a reaction between the reactive polyamine and polyepoxide is characterized by a second gel time at a temperature of 25° C.; and the ratio of the second gel time to the first gel time is greater than 2.

A multiple cure coreactive composition provided by the present disclosure can comprise a reactive polyamine; a polyfunctional Michael acceptor, a polyepoxide, or a combination thereof; and an amine-reactive compound.

A reactive polyamine, a polyfunctional Michael acceptor, and a polyepoxide can include any of those disclosed herein.

An amine-reactive compound can comprise, for example, a polyfunctional cyclic carbonate, a polyfunctional anhydride, a polyfunctional acetoacetate, or a combination of any of the foregoing. An amine-reactive compound can comprise a prepolymer, a monomer, or a combination thereof. An amine-reactive compound can have an average amine-reactive functionality, for example, from 2 to 10, from 2 to 6, or from 2 to 4.

In a multiple cure coreactive composition, a reaction between the reactive polyamine and the amine-reactive compound is characterized by a first gel time at a temperature of 25° C.; a reaction between the reactive polyamine and the polyfunctional Michael acceptor and/or polyepoxide is characterized by a second gel time at a temperature of 25° C.; and the ratio of the first gel time to the second gel time is greater than 2.

Examples of suitable polyfunctional cyclic carbonates include polyfunctional cyclic carbonates derived from propylene carbonate, ethylene carbonate, butylene carbonate, or glycerin carbonate.

Examples of suitable polyfunctional anhydrides and anhydride groups include THPA-tetrahydrophthalic acid anhydride, maleic anhydride, phthalic anhydride, tremolitic, acetic anhydride, dodecenyl succinic anhydride, naphthalene tetracarboxylic dianhydride, maleic anhydride, organic acid anhydrides, polycarboxylic anhydrides, such as nadic anhydride, methylnadic anhydride, phthalic anhydride, tetrahydrophthalic anhydride, hexahydrophthalic anhydride, methyltetrahydrophthalic anhydride, methylhexahydrophthalic anhydride, endomethylenetetrahydrophthalic anhydride, hexachloroendomethylene-tetrahydrophthalic anhydride, trimellitic anhydride, pyromellitic dianhydride, maleic anhydride, succinic anhydride, nonenylsuccinic anhydride, dodecenylsuccinic anhydride, polysebacic polyanhydride, and polyazelaic polyanhydride.

An amine-reactive compound can comprise an amine-reactive prepolymer having two or more amine-reactive groups such as two or more cyclic carbonate groups, anhydride groups, and/or acetoacetate group. An amine-reactive prepolymer can have a prepolymer backbone as disclosed herein.

A summary of chemical reactions between the reactants of certain coreactive compositions provided by the present disclosure is provided in Table 1.

TABLE 1
Reactions between the compounds.

| | Component 2 | |
|---|---|---|
| Component 1 | Coreactive Compound | Reactions |
| Polythiol | Polyfunctional Michael | Thiol-Michael acceptor (F) ¹ |
| and | acceptor | Amine-Michael acceptor (S) ¹ |
| Reactive | Polyepoxide | Thiol-epoxy (F) |
| Polyamine | | Amine-epoxy (S) |
| | Polyfunctional Michael | Thiol-Michael acceptor (F) |
| | acceptor | Amine-Michael acceptor (S) |
| | Polyepoxide | Thiol-epoxy (F) |
| | | Amine-epoxy (S) |
| | Polyfunctional Michael | Thiol-Michael acceptor (F) |
| | acceptor | Amine-Michael acceptor (S) |
| | Polyfunctional cyclic | Amine-cyclic carbonate |
| | carbonate | |
| | Michael acceptor | Thiol-Michael acceptor (F) |
| | Polyanhydride | Amine-Michael acceptor (S) |
| | | Amine-anhydride (F) |
| | Polyepoxide | Thiol-epoxide (F) |
| | Polyfunctional cyclic | Amine-epoxide (S) |
| | carbonate | Amine-cyclic carbonate (F) |
| | Polyepoxide | Thiol-epoxy (F) |
| | Polyacetoacetate | Amine-epoxy (S) |
| | | Amine-acetoacetate (F) |
| | Polyepoxide | Thiol-epoxy (F) |
| | Polyanhydride | Amine-epoxy (S) |
| | | Amine-anhydride (F) |
| | Polyisocyanate | Thiol-isocyanate (F) |
| | | Amine-isocyanate (S) |

¹ Relative reaction rates indicating a fast reaction (F) compared to a slower reaction (S).

A fast reaction can have a reaction rate, for example, that is greater than 2 times the reaction rate of the slower reaction, greater than 4 times, greater than 6 times, greater than 8 times, or greater than 10 times the reaction rate of the slower reaction.

Referring to Table 1, a first component of a coreactive composition can comprise a polythiol and a coreactive polyamine, and a second component can comprise a coreactive compound such as a Michael acceptor and/or a polyepoxide, or a polyisocyanate. The second component can optionally comprise a polyfunctional cyclic carbonate, a polyanhydride, and/or a polyacetoacetate.

Examples of expected reactions between the reactants of the first and second components are also identified. In these reactions, the amine-catalyzed reaction between the polythiol and the Michael acceptor, polyepoxide and/or polyisocyanate is expected to be faster than the reaction between the reactions between the amine-reactive compound and the polyamine.

A multiple cure coreactive composition provided by the present disclosure can have an equivalents ratio of thiol and amine groups to reactive groups of the coreactive compound such as Michael acceptor group, epoxy groups and/or isocyanate groups, for example, from 1.0:1.5 to 1.5:1.0, such as from 1.0:1.4 to 1.4:1.0, from 1.0:1.3 to 1.3:1.0, from 1.0:1.2 to 1.2:1.0, r from 1.0:1.1 to 1.1:1.0, from 1.0:1.05 to 1.05:1.0, or from 1.0:1.02 to 1.02:1.0.

A multiple cure coreactive composition provided by the present disclosure can have approximately a 1:1 equivalents ratio of thiol and amine groups to reactive groups derived from the reactive compound such as Michael acceptor groups, epoxy groups, and/or isocyanate groups.

A multiple cure coreactive composition provided by the present disclosure can have an equivalents ratio of thiol and amine groups to reactive groups of the reactive compound and amine-reactive groups, for example, from 1.0:1.5 to 1.5:1.0, such as from 1.0:1.4 to 1.4:1.0, from 1.0:1.3 to 1.3:1.0, from 1.0:1.2 to 1.2:1.0, or from 1.0:1.1 to 1.1:1.0, from 1.0:1.05 to 1.05:1.0, or from 1.0:1.02 to 1.02:1.0.

A multiple cure coreactive composition provided by the present disclosure can have approximately a 1:1 equivalents ratio of thiol and amine groups to reactive groups derived from the reactive compound and an amine-reactive compound.

Referring to Table 1, the equivalent ratio of reactive groups derived from the compounds in Component 1 to the reactive groups derived from the compounds in Component 2 can be approximately 1:1.

A multiple cure coreactive composition provided by the present disclosure can have percent hydrogen equivalents derived from amine groups to the hydrogen equivalents derived from the polythiol from 10% to 95%, such as from 10% to 75%, from 10% to 55%, from 10% to 35%, or from 10% to 25%.

A multiple cure coreactive composition provided by the present disclosure can have percent hydrogen equivalents derived from amine groups to the hydrogen equivalents derived from the polythiol greater than 5%, greater than 10%, greater than 25%, greater than 35%, greater than 55%, or greater than 75%.

A multiple cure coreactive composition provided by the present disclosure can have percent hydrogen equivalents derived from amine groups to the hydrogen equivalents derived from the polythiol less than 95%, less than 75%, less than 55%, less than 35%, less than 25%, or less than 10%.

A multiple cure coreactive composition provided by the present disclosure can be characterized, for example, by a gel time from 10 seconds to 20 minutes at a temperature of 25° C., from 10 seconds to 15 minutes, from 10 seconds to 10 minutes, from 10 seconds to 5 minutes, from 10 seconds to 150 seconds, or from 10 seconds to 60 seconds at a temperature of 25° C.

A multiple cure coreactive composition provided by the present disclosure can be characterized, for example, by a gel time greater than 10 seconds at a temperature of 25° C., greater than 1 minute, greater than 2 minutes greater than 5 minutes, greater than 10 minutes, greater than 15 minutes, or greater than 20 minutes at a temperature of 25° C.

A multiple cure coreactive composition provided by the present disclosure can be characterized, for example, by a gel time less than 20 minutes at a temperature of 25° C., less than 15 minutes, less than 10 minutes, less than 5 minutes, less than 150 seconds, or less than 60 seconds at a temperature of 25° C.

A multiple cure coreactive composition provided by the present disclosure can be a thermosetting composition.

A multiple cure coreactive composition provided by the present disclosure can fully cure at room temperature such as a temperature from 20° C. to 30° C. A coreactive composition can fully cure at room temperature, such as a temperature from 20° C. to 30° C. within, for example, 1 day, 3 days 7 days, or 14 days. A multiple cure coreactive composition can fully cure at room temperature, such as a temperature from 20° C. to 30° C. within, for example, within more than 1 day, more 3 days, for than 7 days or more than 14 days. A multiple cure coreactive composition can fully cure at room temperature, such as a temperature from 20° C. to 30° C., within, for example, less than 1 day, less than 3 days, less than 7 days, or less than 14 days.

A multiple cure coreactive composition can be fully cured by heating the multiple cure coreactive composition to a temperature greater than 30° C., greater than 50° C., to greater than 70° C. for more than 6 hours, more than 12 hours, more than 24 hours, more than 36 hours, or more than 48 hours.

A multiple cure coreactive composition provided by the present disclosure in which the reactive polyamine acts as a catalyst for the reaction between the polythiol and the reactive compound, the gel time at a temperature from 20° C. to 30° C. such as 25° C., and consequently the gel time of the coreactive composition, can be modified by varying the relative amounts of the polythiol and reactive polyamine in the multiple cure coreactive composition.

For example, increasing the mol % of the reactive polyamine relative to the mol % of the polythiol can increase the reaction rate between the polythiol and the coreactive compound, and thereby decrease the gel time of the coreactive composition.

Similarly, increasing the hydrogen equivalents derived from the reactive polyamine in the multiple cure coreactive composition can reduce the gel time.

By adjusting the amine equivalents derived from the reactive polyamine in the multiple cure coreactive composition the gel time of the multiple cure coreactive composition can be adjusted to facilitate three-dimensional printing at a desired print speed. For example, a higher equivalents ratio of the reactive polyamine can be used with high printing speeds, and a lower content of the reactive polyamine can be used with slower print speeds.

The amount of the reactive polyamine can be dynamically changed during printing such that different parts can be fabricated using different print speeds. For example, certain portions of an object may have detail that is best fabricated using slower print speeds, while other portions of the object can be fabricated at higher print speeds. During the three-dimensional printing operation, the amount of the reactive polyamine can be changed such that the gel time of the coreactive composition is slower at slower print speeds, and faster at faster print speeds. For coreactive compositions characterized by a single gel time throughout the printing operation, the print speed might not be able to accommodate slow print speeds without having the nozzle clog.

Dynamically changing the mol % ratio of the polythiol, the reactive polyamine, and/or the coreactive compound in the multiple cure coreactive composition can also be used to modify the material properties of different portions of the object during the three-dimensional printing operation.

A multiple cure coreactive composition can have a tack free time, for example, is greater than 2 min, greater than 5 min, greater than 10 min, greater than 20 min, greater than 40 min, greater than 60 min, greater than 120 min, greater than 240 min, or greater than 480 min, as determined using the cotton ball test method. A multiple cure coreactive composition can have a tack free time, for example, from 2 min to 500 min, from 10 min to 400 min, from 30 min to 300 min, or from 60 min to 200 min, as determined using the cotton ball test method. A multiple cure coreactive composition can have a tack free time, for example, less than 500 min, less than 400 min, less than 300 min, less than 200 min, less than 100 min, or less than 50 min, as determined using the cotton ball test method. “Tack free time” refers to the duration from the time when the multiple cure coreactive composition is first formed to the time when the multiple cure coreactive composition is no longer tack free, where tack free is determined by applying a polyethylene sheet to the surface of the multiple cure coreactive composition with hand pressure and observing whether material adheres to the surface of the polyethylene sheet. The multiple cure coreactive composition is considered to be tack free if the polyethylene sheet separates easily from the layer.

A multiple cure coreactive composition can have an initial, as-deposited, viscosity, for example, from 1E2 poise to 1E7 poise, from 5E2 poise to 5E6 poise, from 1E3 poise to 1E5 poise, or from 5E3 poise to 5E4 poise, where viscosity is determined using a Brookfield rheometer fitted with a #7 paddle at 2 rpm and 25° C. A multiple cure coreactive composition can have an initial viscosity, for example, greater than 1E2 poise, greater than 5E2 poise, greater than 1E3 poise, greater than 5E3 poise, greater than 1E4 poise, greater than 1E5 poise, or greater than 1E6 poise. A multiple cure coreactive composition can have an initial viscosity, for example, less than 1E7 poise, less than 1E6 poise, less than 1E5 poise, less than 1E4 poise, or less than 1E3 poise.

Each of the polythiol, the reactive polyamine, and the coreactive compound can independently comprise a monomeric compound, a combination of monomeric compounds, a prepolymer, a combination of prepolymers, or a combination of any of the foregoing.

A monomeric compound can have a molecular weight, for example, less than 1,000 Da, less than 800 Da less than 600 Da, less than 500 Da, less than 400 Da, or less than 300 Da. A monomer can have a molecular weight, for example, from 100 Da to 1,000 Da, from 100 Da to 800 Da, from 100 Da to 600 Da, from 150 Da, to 550 Da, or from 200 Da to 500 Da. A monomer can have a molecular weight greater than 100 Da, greater than 200 Da, greater than 300 Da, greater than 400 Da, greater than 500 Da, greater than 600 Da, or greater than 800 Da.

A prepolymer can have a number average molecular weight, for example, less than 10,000 Da, less than 8,000 Da, less than 6,000 Da, less than 4,000 Da, or less than 2,000 Da. A prepolymer can have a number average molecular weight, for example, greater than 2,000 Da, greater than 4,000 Da, greater than 6,000 Da, or greater than 8,000 Da. A prepolymer can have a number average molecular weight, for example, from 2,000 Da to 10,000 Da, from 3,000 Da to 9,000 Da, from 4,000 Da to 8,000 Da, or from 5,000 Da to 7,000 Da.

Prepolymers can be liquid at 25° C. and can have a glass transition temperature T_{g}, for example, less than −20° C., less than −30° C., or less than −40° C., where the glass transition temperature T_{g} is determined by Dynamic Mass Analysis (DMA) using a TA Instruments Q800 apparatus with a frequency of 1 Hz, an amplitude of 20 microns, and a temperature ramp of −80° C. to 25° C., with the T_{g} identified as the peak of the tan 6 curve.

Prepolymers can exhibit a viscosity, for example, within a range from 20 poise to 500 poise (2 Pa-sec to 50 Pa-sec), from 20 poise to 200 poise (2 Pa-sec to 20 Pa-sec) or from 40 poise to 120 poise (4 Pa-sec to 12 Pa-sec), measured using a Brookfield CAP 2000 viscometer, with a No. 6 spindle, at speed of 300 rpm, and a temperature of 25° C.

A prepolymer backbone can determine properties of the cured composition such as, for example, the tensile strength, % elongation, impact strength, thermal resistance, hydrolytic stability, and chemical resistance of the cured polymer.

A prepolymer can comprises any suitable backbone and can be selected to obtain a desired property of the cured polymer. A prepolymer backbone can be selected, for example, based on the end use requirements of a part. For example, a prepolymer backbone can be selected based considerations of tensile strength, % elongation, thermal resistance, chemical resistance, low temperature flexibility, hardness, and a combination of any of the foregoing. The selection of a prepolymer for use in a particular prepolymer can also be based on cost considerations.

Prepolymers can include copolymers such as alternating copolymers, random copolymers, and/or block copolymers. For example, prepolymers can comprise segments that impart desired properties to a prepolymer backbone such as flexibility.

A prepolymer can comprise segments having different chemical structure and properties within the prepolymer backbone. The segments can be distributed randomly, in a regular distribution, or in blocks. The segments can be used to impart certain properties to the prepolymer backbone. For example, the segments can comprise flexible linkages such as thioether linkages into the polymer backbone. Segments having pendent groups can be incorporated into the prepolymer backbone to disrupt the symmetry of the prepolymer backbone. The segments can be introduced via the reactants used to prepare a sulfur-containing prepolymer and/or the lower molecular weight sulfur-containing prepolymers can be reacted with compounds containing the segments.

A prepolymer can comprise a prepolymer backbone that can be terminated in suitable functional groups as appropriate for a particular curing chemistry, such as relevant to the present invention, reactive thiol groups, Michael acceptor groups, epoxy groups, isocyanate groups, amine groups, or amine-reactive groups.

A prepolymer can have any suitable backbone as appropriate for desired cured properties.

For example, a prepolymer backbone can comprise a polythioether, a polysulfide, a polyformal, a polyisocyanate, a polyurea, polycarbonate, polyphenylene sulfide, polyethylene oxide, polystyrene, acrylonitrile-butadiene-styrene, polycarbonate, styrene acrylonitrile, poly(methylmethacrylate), polyvinylchloride, polybutadiene, polybutylene terephthalate, poly(p-phenyleneoxide), polysulfone, polyethersulfone, polyethylenimine, polyphenylsulfone, acrylonitrile styrene acrylate, polyethylene, syndiotactic or isotactic polypropylene, polylactic acid, polyamide, ethylene-vinyl acetate homopolymer or copolymer, polyurethane, copolymers of ethylene, copolymers of propylene, impact copolymers of propylene, polyetheretherketone, polyoxymethylene, syndiotactic polystyrene (SPS), polyphenylene sulfide (PPS), liquid crystalline polymer (LCP), homo- and copolymer of butene, homo- and copolymers of hexene; and combinations of any of the foregoing.

Examples of other suitable prepolymer backbones include polyolefins (such as polyethylene, linear low density polyethylene (LLDPE), low density polyethylene (LDPE), high density polyethylene, polypropylene, and olefin copolymers), styrene/butadiene rubbers (SBR), styrene/ethylene/butadiene/styrene copolymers (SEBS), butyl rubbers, ethylene/propylene copolymers (EPR), ethylene/propylene/diene monomer copolymers (EPDM), polystyrene (including high impact polystyrene), poly(vinyl acetates), ethylene/vinyl acetate copolymers (EVA), poly(vinyl alcohols), ethylene/vinyl alcohol copolymers (EVOH), poly(vinyl butyral), poly(methyl methacrylate) and other acrylate polymers and copolymers (including such as methyl methacrylate polymers, methacrylate copolymers, polymers derived from one or more acrylates, methacrylates, ethyl acrylates, ethyl methacrylates, butyl acrylates, butyl methacrylates and the like), olefin and styrene copolymers, acrylonitrile/butadiene/styrene (ABS), styrene/acrylonitrile polymers (SAN), styrene/maleic anhydride copolymers, isobutylene/maleic anhydride copolymers, ethylene/acrylic acid copolymers, poly(acrylonitrile), polycarbonates (PC), polyamides, polyesters, liquid crystalline polymers (LCPs), poly(lactic acid), poly(phenylene oxide) (PPO), PPO-polyamide alloys, polysulfone (PSU), polyetherketone (PEK), polyetheretherketone (PEEK), polyimides, polyoxymethylene (POM) homo- and copolymers, polyetherimides, fluorinated ethylene propylene polymers (FEP), poly(vinyl fluoride), poly(vinylidene fluoride), poly(vinylidene chloride), and poly(vinyl chloride), polyurethanes (thermoplastic and thermosetting), aramides (such as Kevlar® and Nomex®), polytetrafluoroethylene (PTFE), polysiloxanes (including polydimethylenesiloxane, dimethylsiloxane/vinylmethylsiloxane copolymers, vinyldimethylsiloxane terminated poly(dimethylsiloxane)), elastomers, epoxy polymers, polyureas, alkyds, cellulosic polymers (such as ethyl cellulose, ethyl hydroxyethyl cellulose, carboxymethyl cellulose, cellulose acetate, cellulose acetate propionates, and cellulose acetate butyrates), polyethers and glycols such as poly(ethylene oxide)s (also known as poly(ethylene glycol)s, poly(propylene oxide)s (also known as poly(propylene glycol)s, and ethylene oxide/propylene oxide copolymers, acrylic latex polymers, polyester acrylate oligomers and polymers, polyester diol diacrylate polymers, and UV-curable resins.

Prepolymers having an elastomeric backbone can also be used. Examples of suitable prepolymers having n elastomeric backbone include polyethers, polybutadienes, fluoroelastomers, perfluoroelastomers, ethylene/acrylic copolymers, ethylene propylene diene terpolymers, nitriles, polythiolamines, polysiloxanes, and combinations of any of the foregoing.

An elastomeric prepolymer can comprise any suitable elastomeric prepolymer. Examples of suitable prepolymers having an elastomeric backbone include polyethers, polybutadienes, fluoroelastomers, perfluoroelastomers, ethylene/acrylic copolymers, ethylene propylene diene terpolymers, nitriles, polythiolamines, polysiloxanes, chlorosulfonated polyethylene rubbers, isoprenes, neoprenes, polysulfides, polythioethers, silicones, styrene butadienes, and combinations of any of the foregoing. The elastomeric prepolymer can comprise a polysiloxane, such as, for example, a polymethylhydrosiloxane, polydimethylsiloxane, polyethylhydrosiloxane, polydiethylsiloxane, or a combination of any of the foregoing. The elastomeric prepolymer can comprise terminal functional groups that have a low reactivity with amine and isocyanate groups such as silanol groups. The elastomeric prepolymer can comprise, for example, a polydimethylsiloxane prepolymer, such as a silanol-terminal polysiloxane prepolymer, such as a silanol-terminated polydimethylsiloxane prepolymer.

Examples of prepolymers having a chemically resistant backbone include polytetrafluorethylene, polyvinylidene difluoride, polyethylenetetrafluoroethylene, fluorinated ethylene propylene, perfluoroalkoxy, ethylene chlorotrifluorethylene, polychlorotrifluoroethylene, fluorinated ethylene propylene polymers polyamide, polyethylene, polypropylene, ethylene-propylene, fluorinated ethylene-propylene, polysulfone, polyarylether sulfone, polyether sulfone, polyimide, polyethylene terephthalate, polyetherketone, polyetherether ketone, polyetherimide, polyphenylene sulfide, polyarylsulfone, polybenzimidazole, polyamideimide, liquid crystal polymers, and combinations of any of the foregoing.

For parts where chemical resistance is required, prepolymers having a sulfur-containing backbone can be used. The chemical resistance can be with respect to cleaning solvents, fuels, hydraulic fluids, lubricants, oils, and/or salt spray. Chemical resistance refers to the ability of a part to maintain acceptable physical and mechanical properties following exposure to atmospheric conditions such as moisture and temperature and following exposure to chemicals such as cleaning solvents, fuels, hydraulic fluid, lubricants, and/or oils. In general, a chemically resistant part has exhibits a % swell less than 25%, less than 20%, less than 15%, or less than 10%, following immersion in a chemical for 7 days at 70° C., where % swell is determined according to EN ISO 10563.

Examples of prepolymers that exhibit high solvent resistance include fluoropolymers, ethylene propylene diene terpolymer (EPDM), and other chemically resistant prepolymers disclosed herein, cured polymeric matrices having a high crosslinking density, chemically resistant organic filler such as polyamides, polyphenylene sulfides, and polyethylenes, or a combination of any of the foregoing. Other examples of chemically resistant prepolymers include polytetrafluorethylene, polyvinylidene difluoride, polyethylenetetrafluoroethylene, fluorinated ethylene propylene, perfluoroalkoxy, ethylene chlorotrifluorethylene, polychlorotrifluoroethylene, fluorinated ethylene propylene polymers polyamide, polyethylene, polypropylene, ethylene-propylene, fluorinated ethylene-propylene, polysulfone, polyarylether sulfone, polyether sulfone, polyimide, polyethylene terephthalate, polyetherketone, polyetherether ketone, polyetherimide, polyphenylene sulfide, polyarylsulfone, polybenzimidazole, polyamideimide, liquid crystal polymers, or combinations of any of the foregoing.

Examples of prepolymers that exhibit low temperature flexibility include silicones, polytetrafluoroethylenes, polythioethers, polysulfides, polyformals, polybutadienes, certain elastomers, and combinations of any of the foregoing.

Examples of prepolymers that exhibit hydrolytic stability include silicones, polytetrafluoroethylenes, polythioethers, polysulfides, polyformals, polybutadienes, certain elastomers, and combinations of any of the foregoing, and compositions having a high crosslinking density.

Examples of prepolymers that exhibit high temperature resistance can comprise, for example, prepolymers such as silicones, polytetrafluoroethylenes, polythioethers, polysulfides, polyformals, polybutadienes, certain elastomer, and combinations of any of the foregoing; and prepolymers having a high functionality to provide a cured polymer network characterized by a high crosslinking density.

Examples of prepolymers that exhibit high tensile include silicones and polybutadiene, compositions having high crosslinking density, inorganic filler, and combinations of any of the foregoing.

A prepolymer can comprise a sulfur-containing prepolymer or a combination of sulfur-containing prepolymers.

A sulfur-containing prepolymer refers to a prepolymer that has one or more thioether —Sₙ— groups, where n can be, for example, 1 to 6, in the backbone of the prepolymer. Prepolymers that contain only thiol or other sulfur-containing groups either as terminal groups or as pendent groups of the prepolymer are not encompassed by sulfur-containing prepolymers. The prepolymer backbone refers to the portion of the prepolymer having repeating segments. Thus, a prepolymer having the structure of HS—R—R(—CH₂—SH)—[—R—(CH₂)₂—S(O)₂—(CH₂)—S(O)₂]ₙ—CH═CH₂ where each R is a moiety that does not contain a sulfur atom, is not encompassed by a sulfur-containing prepolymer. A prepolymer having the structure HS—R—R(—CH₂—SH)—[—R—(CH₂)₂—S(O)₂—(CH₂)—S(O)₂]—CH═CH₂ where at least one R is a moiety that contains a sulfur atom, such as a thioether group, is encompassed by a sulfur-containing prepolymer.

Sulfur-containing prepolymers can impart chemical resistance to a cured polymer.

A prepolymer backbone that exhibits chemical resistance can have a high sulfur content. For example, a sulfur-containing prepolymer backbone can have a sulfur content greater than 10 wt %, greater than 12 wt %, greater than 15 wt %, greater than 18 wt %, greater than 20 wt %, or greater than 25 wt %, where wt % is based on the total weight of the prepolymer backbone. A chemically resistant prepolymer backbone can have a sulfur content, for example, from 10 wt % to 25 wt %, from 12 wt % to 23 wt %, from 13 wt % to 20 wt %, or from 14 wt % to 18 wt %, where wt % is based on the total weight of the prepolymer backbone.

A multiple cure coreactive composition can comprise, for example, from 40 wt % to 80 wt %, from 40 wt % to 75 wt %, from 45 wt % to 70 wt %, or from 50 wt % to 70 wt % of a sulfur-containing prepolymer or combination of sulfur-containing prepolymers, where wt % is based on the total weight of the multiple cure coreactive composition. A multiple cure coreactive composition can comprise, for example, greater than 40 wt %, greater than 50 wt %, greater than 60 wt %, greater than 70 wt %, greater than 80 wt %, or greater than 90 wt % of a sulfur-containing prepolymer or combination of sulfur-containing prepolymer, where wt % is based on the total weight of the multiple cure coreactive composition. A multiple cure coreactive composition can comprise, for example, less than 90 wt %, less than 80 wt %, less than 70 wt %, less than 60 wt %, less than 50 wt %, or less than 40 wt % of a sulfur-containing prepolymer or combination of sulfur-containing prepolymers, where wt % is based on the total weight of the multiple cure coreactive composition.

Examples of prepolymers having a sulfur-containing backbone include polythioether prepolymers, polysulfide prepolymers, sulfur-containing polyformal prepolymers, monosulfide prepolymers, and a combination of any of the foregoing.

A prepolymer can comprise a polythioether prepolymer or a combination of polythioether prepolymers.

A polythioether prepolymer can comprise a polythioether prepolymer comprising at least one moiety having the structure of Formula (6), a thiol-terminated polythioether prepolymer of Formula (6a), a terminal-modified polythioether of Formula (6b), or a combination of any of the foregoing:

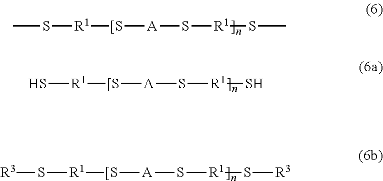

wherein,
n can be an integer from 1 to 60;
each R¹ can independently be selected from C₂₋₁₀ alkanediyl, C₆₋₈ cycloalkanediyl, C₆₋₁₄ alkanecycloalkanediyl, C₅₋₈ heterocycloalkanediyl, and —[(CHR)ₚ—X-]_{q}(CHR)ᵣ—, where,
   p can be an integer from 2 to 6;
   q can be an integer from 1 to 5;
   r can be an integer from 2 to 10;
   each R can independently be selected from hydrogen and methyl; and
   each X can independently be selected from O, S, and S—S; and
each A can independently be a moiety derived from a polyvinyl ether of Formula (7) or a polyalkenyl polyfunctionalizing agent of Formula (8):

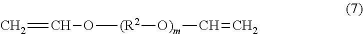

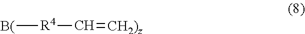

wherein,
   m can be an integer from 0 to 50;
   each R² can independently be selected from C₁₋₁₀ alkanediyl, C₆₋₈ cycloalkanediyl, C₆₋₁₄ alkanecycloalkanediyl, and —[(CHR)ₚ—X-]_{q}(CHR)ᵣ—, wherein p, q, r, R, and X are as defined as for R¹;
   each R³ can independently be moiety comprising a terminal reactive group;
   B represents a core of a z-valent, polyalkenyl polyfunctionalizing agent B(—R⁴—CH═CH₂)_{z} wherein,
   z can be an integer from 3 to 6; and
   each R⁴ can independently be selected from C₁₋₁₀ alkanediyl, C₁₋₁₀ heteroalkanediyl, substituted C₁₋₁₀ alkanediyl, and substituted C₁₋₁₀ heteroalkanediyl.

In moieties of Formula (6) and prepolymers of Formula (6a)-(6b), each A can independently be selected from a moiety of Formula (7a) and a moiety of Formula (8a):

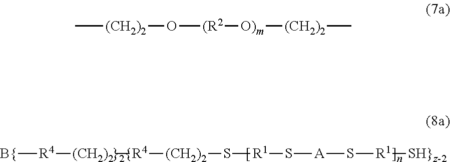

where m, R¹, R², R⁴, A, B, m, n, and z are defined as in Formula (6), Formula (7), or Formula (8).

Methods of synthesizing sulfur-containing polythioethers are disclosed, for example, in U.S. Pat. No. 6,172,179.

The backbone of a thiol-terminated polythioether prepolymer can be modified to improve the properties such as adhesion, tensile strength, elongation, UV resistance, hardness, and/or flexibility of sealants and coatings prepared using polythioether prepolymers. For example, adhesion promoting groups, antioxidants, metal ligands, and/or urethane linkages can be incorporated into the backbone of a polythioether prepolymer to improve one or more performance attributes. Examples of backbone-modified polythioether prepolymers are disclosed, for example, in U.S. Pat. No. 8,138,273 (urethane containing), U.S. Pat. No. 9,540,540 (sulfone-containing), U.S. Pat. No. 8,952,124 (bis(sulfonyl)alkanol-containing), U.S. Pat. No. 9,382,642 (metal-ligand containing), U.S. Application Publication No. 2017/0114208 (antioxidant-containing), PCT International Publication No. WO 2018/085650 (sulfur-containing divinyl ether), and PCT International Publication No. WO 2018/031532 (urethane-containing). Polythioether prepolymers include prepolymers described in U.S. Application Publication Nos. 2017/0369737 and 2016/0090507.

Examples of suitable thiol-terminated polythioether prepolymers are disclosed, for example, in U.S. Pat. No. 6,172,179. A thiol-terminated polythioether prepolymer can comprise Permapol® P3.1E, Permapol® P3.1E-2.8, Permapol® L56086, or a combination of any of the foregoing, each of which is available from PPG Aerospace. These Permapol® products are encompassed by the thiol-terminated polythioether prepolymers of Formula (6), (6a), and (6b). Thiol-terminated polythioethers include prepolymers described in U.S. Pat. No. 7,390,859 and urethane-containing polythiols described in U.S. Application Publication Nos. 2017/0369757 and 2016/0090507.

A sulfur-containing prepolymer can comprise a polysulfide prepolymer or a combination of polysulfide prepolymers.

A polysulfide prepolymer refers to a prepolymer that contains one or more polysulfide linkages, i.e., —Sₓ— linkages, where x is from 2 to 4, in the prepolymer backbone. A polysulfide prepolymer can have two or more sulfur-sulfur linkages. Suitable thiol-terminated polysulfide prepolymers are commercially available, for example, from AkzoNobel and Toray Industries, Inc. under the tradenames Thioplast® and from Thiokol-LP®, respectively.

Examples of suitable polysulfide prepolymers are disclosed, for example, in U.S. Pat. Nos. 4,623,711; 6,172,179; 6,509,418; 7,009,032; and 7,879,955.

Examples of suitable thiol-terminated polysulfide prepolymers include Thioplast® G polysulfides such as Thioplast® GI, Thioplast® G4, Thioplast® G10, Thioplast® G12, Thioplast® G21, Thioplast® G22, Thioplast® G44, Thioplast® G122, and Thioplast® G131, which are commercially available from AkzoNobel. Thioplast® G resins are liquid thiol-terminated polysulfide prepolymers that are blends of di- and tri-functional molecules where the difunctional thiol-terminated polysulfide prepolymers have the structure of Formula (9) and the trifunctional thiol-terminated polysulfide polymers can have the structure of Formula (10):

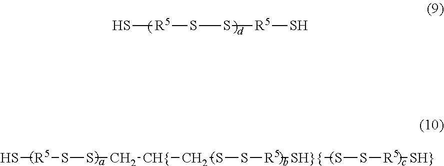

where each R⁵ is —(CH₂)₂—O—CH₂—O—(CH₂)₂—, and d=a+b+c, where the value for d may be from 7 to 38 depending on the amount of the trifunctional cross-linking agent (1,2,3-trichloropropane; TCP) used during synthesis of the polysulfide prepolymer. Thioplast® G polysulfides can have a number average molecular weight from less than 1,000 Da to 6,500 Da, a SH content from 1% to greater than 5.5%, and a cross-linking density from 0% to 2.0%.

Polysulfide prepolymers can further comprise a terminal-modified polysulfide prepolymer having the structure of Formula (9a), a terminal modified polysulfide prepolymer having the structure of Formula (10a) or a combination thereof:

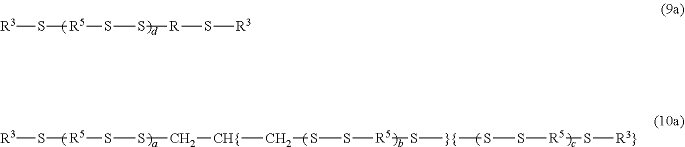

where d, a, b, c, and R⁵ are defined as for Formula (9) and Formula (10), and R³ is a moiety comprising a terminal reactive group.

Examples of suitable thiol-terminated polysulfide prepolymers also include Thiokol® LP polysulfides available from Toray Industries, Inc. such as Thiokol® LP2, Thiokol® LP3, Thiokol™ LP12, Thiokol® LP23, Thiokol® LP33, and Thiokol® LP55. Thiokol® LP polysulfides have a number average molecular weight from 1,000 Da to 7,500 Da, a —SH content from 0.8% to 7.7%, and a cross-linking density from 0% to 2%. Thiokol™ LP polysulfide prepolymers have the structure of Formula (11) and terminal-modified polysulfide prepolymers can have the structure of Formula (11a):

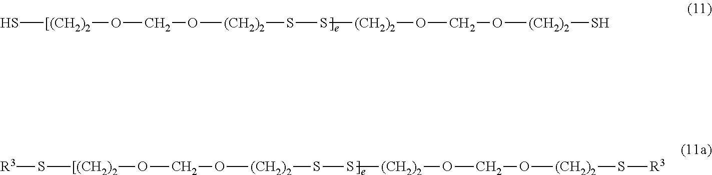

where e can be such that the number average molecular weight from 1,000 Da to 7,500 Da, such as, for example an integer from 8 to 80, and each R³ is a moiety comprising a terminal reactive functional group.

A thiol-terminated sulfur-containing prepolymer can comprise a Thiokol-LP® polysulfide, a Thioplast® G polysulfide, or a combination thereof.

Examples of thiol-terminated polysulfide prepolymers of Formula (11) and (11a) are disclosed, for example, in U.S. Application Publication No. 2016/0152775, in U.S. Pat. No. 9,079,833, and in U.S. Pat. No. 9,663,619.

A polysulfide prepolymer can comprise a polysulfide prepolymer comprising a moiety of Formula (12), a thiol-terminated polysulfide prepolymer of Formula (12a), a terminal-modified polysulfide prepolymer of Formula (12b), or a combination of any of the foregoing:

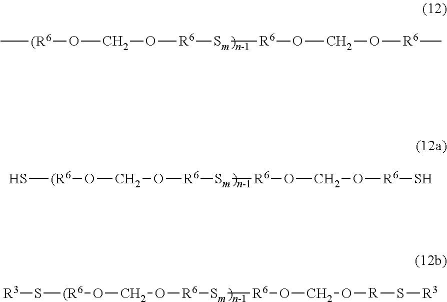

where R⁶ is C₂₋₄ alkanediyl, m is an integer from 1 to 8, and n is an integer from 2 to 370; and each R³ is independently a moiety comprising a terminal reactive functional group.

In moieties of Formula (12) and prepolymers of Formula (12a)-(12b), m can have an average value, for example, greater than 1, such as from 1.05 to 2, or from 1.1 to 1.8.

In moieties of Formula (12) and prepolymers of Formula (12a)-(12b), m can be, for example, an integer from 1 to 6, and integer from 1 to 4, or an integer 1, 2, 3, 4, 5, 6, 7, or 8.

In moieties of Formula (12) and prepolymers of Formula (12a)-(12b), n can be, for example, an integer from 2 to 200 or an integer from 2 to 100.

In moieties of Formula (12) and prepolymers of Formula (12a)-(12b), each R can independently be selected from ethanediyl, 1,3-propanediyl, 1,1-propanediyl, 1,2-propanediyl, 1,4-butanediyl, 1,1-butanediyl, 1,2-butanediyl, and 1,3-butanediyl.

Polysulfide prepolymers of Formula (12) and polysulfide prepolymers of Formula (12a)-(12b), are disclosed, for example, in JP 62-53354.

A sulfur-containing prepolymer can comprise a sulfur-containing polyformal prepolymer or a combination of sulfur-containing polyformal prepolymers. Sulfur-containing polyformal prepolymers useful in sealant applications are disclosed, for example, in U.S. Pat. No. 8,729,216 and in U.S. Pat. No. 8,541,513.

A sulfur-containing polyformal prepolymer can comprise a moiety of Formula (13), a thiol-terminated sulfur-containing polyformal prepolymer of Formula (13a), a terminal-modified sulfur-containing polyformal prepolymer of Formula (13b), a thiol-terminated sulfur-containing polyformal prepolymer of Formula (13c), a terminal-modified sulfur-containing polyformal prepolymer of Formula (13d), or a combination of any of the foregoing:

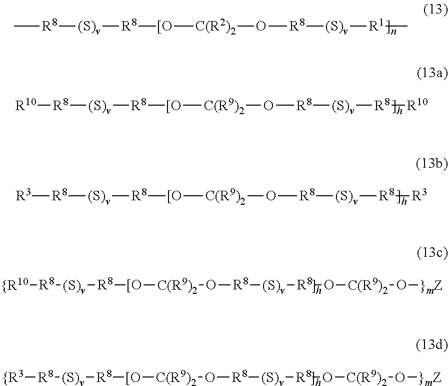

where h can be an integer from 1 to 50; each v can independently be selected from 1 and 2; each R⁸ can be C₂₋₆ alkanediyl; and each R⁹ can independently be selected from hydrogen, C₁₋₆ alkyl, C₇_12 phenylalkyl, substituted C₇₋₁₂ phenylalkyl, C₆₋₁₂ cycloalkylalkyl, substituted C₆₋₁₂ cycloalkylalkyl, C₃₋₁₂ cycloalkyl, substituted C₃₋₁₂ cycloalkyl, C₆₋₁₂ aryl, and substituted C₆₋₁₂ aryl; each R¹⁰ is a moiety comprising a terminal thiol group; and each R³ is independently a moiety comprising a terminal reactive functional group other than a thiol group; and Z can be derived from the core of an m-valent parent polyol Z(OH)ₘ.

In sulfur-containing polyformal moieties of Formula (13) and prepolymers Formula (13a)-(13d), each R¹ can independently be selected from C₂₋₆ alkanediyl, C₂₋₄ alkanediyl, C₂₋₃ alkanediyl, and ethane-1,2-diyl.

In sulfur-containing polyformal moieties of Formula (13) and prepolymers Formula (13a)-(13d), each R¹ can be ethane-1,2-diyl.

In sulfur-containing polyformal moieties of Formula (13) and prepolymers Formula (13a)-(13d), each R² can independently be selected from hydrogen, C₁₋₆ alkyl, C₁₋₄ alkyl, C₁₋₃ alkyl, and C₁₋₂ alkyl. In sulfur-containing polyformal moieties of Formula (13) and prepolymers Formula (13a), each R² can be selected from hydrogen, methyl, and ethyl.

In sulfur-containing polyformal moieties of Formula (13) and prepolymers Formula (13a)-(13d), each R¹ is the same and can be selected from C₂₋₃ alkanediyl such as ethane-1,2-diyl and propane-1,3-diyl; and each R² is the same and can be selected from hydrogen and C₁₋₃ alkyl such as methyl, ethyl, or propyl. In sulfur-containing polyformal moieties of Formula (13) and prepolymers Formula (13a), each R¹ can be ethane-1,2-diyl.

In sulfur-containing polyformal moieties of Formula (13) and prepolymers Formula (13a)-(13d), each R² can be hydrogen. In sulfur-containing polyformal moieties of Formula (13) and prepolymers Formula (13a), each R¹ can be ethane-1,2-diyl and each R² can be hydrogen.

In sulfur-containing polyformal moieties of Formula (13) and prepolymers Formula (13a)-(13b), n can be an integer selected from 1 to 50, an integer from 2 to 40, an integer from 4 to 30, or n can be an integer from 7 to 30.

In sulfur-containing polyformal moieties of Formula (13) and prepolymers Formula (13a)-(13b), each p is the same and can be 1, and each p is the same and can be 2.

A sulfur-containing prepolymer can comprise a monosulfide prepolymer or a combination of monosulfide prepolymers.

A monosulfide prepolymer can comprise a moiety of Formula (14), a thiol-terminated monosulfide prepolymer of Formula (14a), a thiol-terminated monosulfide prepolymer of Formula (14b), a terminal-modified monosulfide prepolymer of Formula (9c), a terminal-modified monosulfide prepolymer of Formula (14d), or a combination of any of the foregoing:

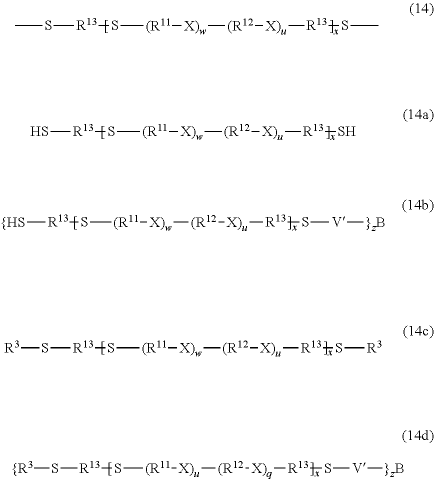

wherein,

each R¹¹ can independently be selected from C₂₋₁₀ alkanediyl, such as C₂₋₆ alkanediyl; C₂₋₁₀ branched alkanediyl, such as C₃₋₆ branched alkanediyl or a C₃₋₆ branched alkanediyl having one or more pendant groups which can be, for example, alkyl groups, such as methyl or ethyl groups; C₆₋₈ cycloalkanediyl; C₆₋₁₄ alkylcycloalkyanediyl, such as C₆₋₁₀ alkylcycloalkanediyl; and C₈₋₁₀ alkylarenediyl;

each R¹² can independently be selected from hydrogen, C₁₋₁₀ n-alkanediyl, such as C₁₋₆ n-alkanediyl, C₂₋₁₀ branched alkanediyl, such as C₃₋₆ branched alkanediyl having one or more pendant groups which can be, for example, alkyl groups, such as methyl or ethyl groups; C₆₋₈ cycloalkanediyl; C₆₋₁₄ alkylcycloalkanediyl, such as C₆₋₁₀ alkylcycloalkanediyl; and C₈₋₁₀ alkylarenediyl;

each R¹³ can independently be selected from hydrogen, C₁₋₁₀ n-alkanediyl, such as C₁₋₆ n-alkanediyl, C₂₋₁₀ branched alkanediyl, such as C₃₋₆ branched alkanediyl having one or more pendant groups which can be, for example, alkyl groups, such as methyl or ethyl groups; C₆₋₈ cycloalkanediyl group; C₆₋₁₄ alkylcycloalkanediyl, such as a C₆₋₁₀ alkylcycloalkanediyl; and C₈₋₁₀ alkylarenediyl;

each X can independently be selected from O and S;

w can be an integer from 1 to 5;

u can be an integer from 0 to 5; and

x can be an integer from 1 to 60, such as from 2 to 60, from 3 to 60, or from 25 to 35;
each R³ is independently selected from a reactive functional group;
B represents a core of a z-valent polyfunctionalizing agent B(—V)_{z} wherein:
   z can be an integer from 3 to 6; and
   each V can be a moiety comprising a terminal group reactive with a thiol group;
each —V′— can be derived from the reaction of —V with a thiol.

Methods of synthesizing thiol-terminated monosulfide comprising moieties of Formula (14) or prepolymers of Formula (14b)-(14c) are disclosed, for example, in U.S. Pat. No. 7,875,666.

A monosulfide prepolymer can comprise a moiety of Formula (15), a thiol-terminated monosulfide prepolymer comprising a moiety of Formula (15a), comprise a thiol-terminated monosulfide prepolymer of Formula (15b), a thiol-terminated monosulfide prepolymer of Formula (15c), a thiol-terminated monosulfide prepolymer of Formula (15d), or a combination of any of the foregoing:

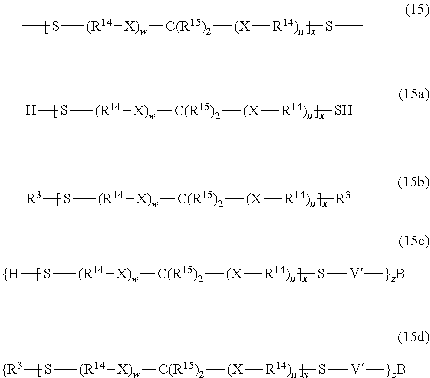

wherein,

each R¹⁴ can independently be selected from C₂₋₁₀ alkanediyl, such as C₂₋₆ alkanediyl; a C₃₋₁₀ branched alkanediyl, such as a C₃₋₆ branched alkanediyl or a C₃₋₆ branched alkanediyl having one or more pendant groups which can be, for example, alkyl groups, such as methyl or ethyl groups; a C₆₋₈ cycloalkanediyl; a C₆₋₁₄ alkylcycloalkyanediyl, such as a C₆₋₁₀ alkylcycloalkanediyl; and a C₈₋₁₀ alkylarenediyl;

each R¹⁵ can independently be selected from hydrogen, C₁₋₁₀ n-alkanediyl, such as a C₁₋₆ n-alkanediyl, C₃₋₁₀ branched alkanediyl, such as a C₃₋₆ branched alkanediyl having one or more pendant groups which can be, for example, alkyl groups, such as methyl or ethyl groups; a C₆₋₈ cycloalkanediyl group; a C₆₋₁₄ alkylcycloalkanediyl, such as a C₆₋₁₀ alkylcycloalkanediyl; and a C₈₋₁₀ alkylarenediyl;

each X can independently be selected from O and S;

w can be an integer from 1 to 5;

u can be an integer from 1 to 5;

x can be an integer from 1 to 60, such as from 2 to 60, from 3 to 60, or from 25 to 35;

each R⁶ is a moiety comprising a terminal functional group;

B represents a core of a z-valent polyfunctionalizing agent B(—V)_{z} wherein:
z can be an integer from 3 to 6; and
each V can be a moiety comprising a terminal group reactive with a thiol group;

each —V′— can be derived from the reaction of —V with a thiol.

Methods of synthesizing monosulfides of Formula (15)-(15d) are disclosed, for example, in U.S. Pat. No. 8,466,220.

Each of the coreactants of a multiple cure coreactive composition provided by the present disclosure such as the polythiol, the reactive polyamine, the coreactive compound, and an optional amine-reactive compound can have a reactive functionality or an average reactive functionality, for example, from 2 to 12, from 2 to 10, from 2 to 8, from 2 to 6, from 2 to 4 or from 2 to 3. Each coreactive component can have a reactive functionality or an average reactive functionality, for example, of 2, 3, 4, 5, 6, 7, 8, 9, 10, 11, or 12.

Each combination of coreactive compounds can comprise coreactive compounds having coreactive functional groups.

A coreactive compound can comprise two or more of the same coreactive functional group.

A coreactive compound can comprise two or more coreactive functional groups in which at least one of the coreactive functional groups is different than another coreactive functional group provided that each of the coreactive functional groups is reactive with the other reactant.

A multiple cure coreactive composition provided by the present disclosure may not comprise a non-reactive catalyst. An objective of the present invention can be to avoid or minimize the use of non-reactive compounds in the cured thermoset. A non-reactive catalyst refers to a catalyst that does not react with one of the coreactants of the multiple cure coreactive composition. Examples of non-reactive catalysts include tertiary amines, free-radical generators such as photoinitiators, thermally initiated free-radical generators, and dark cure catalysts.

The thermal reaction between polythiols and polyfunctional Michael acceptors, polyepoxides and polyisocyanates can be catalyzed by strong bases such as tertiary amines and are often present in amounts from 1 wt % to 10 wt %. The unreacted tertiary amine catalysts can compromise the properties of a cured composition. In a multiple cure coreactive composition provided by the present disclosure, the presence of unreacted amine catalysts in the fully cured composition is avoided by using a reactive polyamine that catalysts the thiol reactions and also reacts with the multiple cure coreactive compound to become incorporated into the cured thermoset polymer network.

A multiple cure coreactive composition provided by the present disclosure can be provided as a two-component system. The two components can be prepared and stored separately.

During use, each component can be simultaneously pumped into a mixer where the two components are combined and mixed to form a multiple cure coreactive composition. Examples of suitable mixers include static mixers and dynamic mixers.

The multiple cure coreactive composition can be extruded through a nozzle to from an extrudate, which can be deposited in successive layers to fabricate an object.

The nozzle as well as the mixer and optionally the pumps and cartridges can be mounted on a translatable gantry under computer control.

A multi-component system can comprise, for example, a two-component system, a three-components system, a four-component system, or other multi-component system. In a multi-component system, each component can comprise constituents that do not coreact or that coreact slowly at the use conditions. For example, coreactants in a component can be sufficiently slow at use conditions such as at temperatures less than 30° C. that the viscosity does not increase to the extent that for a given extrusion rate the nozzle does not clog.

A two-component system can comprise, for example, a first component and second component.

The first component can comprise a polythiol and a reactive polyamine and the second component can comprise a coreactive compound such as a polyfunctional Michael acceptor, a polyepoxide, or a combination thereof.

Examples of suitable reactive constituents for a first component and a second component two-part system are shown in Table 2.

TABLE 2
Constituents for a first component and
a second component two-part system.

| Component 1 | Component 2 |
|---|---|
| Polythiol | Polyfunctional Michael acceptor |
| and/or | Polyfunctional Michael acceptor |
| Reactive | Polyepoxide |
| polyamine | Polyfunctional Michael acceptor |
| | Polyfunctional Cyclic carbonate |
| | Polyfunctional Michael acceptor |
| | Polyfunctional Anhydride |
| | Polyepoxide |
| | Polyfunctional Cyclic carbonate |
| | Polyepoxide |
| | Polyfunctional acetoacetate |
| | Polyepoxide |
| | Polyfunctional anhydride |
| | Polyisocyanate |

Each component of a multicomponent system can independently comprise one or more additives such as any of the additives disclosed herein.

Each of the components of a multicomponent system can have a similar viscosity to facilitate mixing and providing a homogeneous multiple cure coreactive composition. For example, the viscosities of each of the components can be within ±20%, ±15%, ±10%, or ±5%.

A multi-component system provided by the present disclosure can comprise three components. For example, in a three-component system, a first component can comprise a polythiol or combination of polythiols, a second component can comprise a polyamine or a combination of polyamines, and a third component can comprise a Michael acceptor or combination of Michael acceptor.

In a three-component system the third component can further comprise an amine-reactive compound such as a polyisocyanate, a polyfunctional cyclic carbonate, a polyfunctional anhydride, a polyfunctional acetoacetate, or a combination of any of the foregoing.

A multiple cure coreactive composition provided by the present disclosure can comprise one or more additives.

Examples of suitable additives include fillers, adhesion promoters, reactive diluents, plasticizers, rheology modifiers, colorants, catalysts, fire retardants, antioxidants, UV stabilizers, corrosion inhibitors, erosion inhibitors, and combinations of any of the foregoing.

A multiple cure coreactive composition can comprise a filler or combination of filler. A filler can comprise, for example, inorganic filler, organic filler, low-density filler, conductive filler, or a combination of any of the foregoing.

A multiple cure coreactive composition can comprise an inorganic filler or combination of inorganic filler.

An inorganic filler can be included to provide mechanical reinforcement and to control the rheological properties of the composition. Inorganic filler may be added to compositions to impart desirable physical properties such as, for example, to increase the impact strength, to control the viscosity, or to modify the electrical properties of a cured composition.

Inorganic filler useful in a multiple cure coreactive composition include carbon black, calcium carbonate, precipitated calcium carbonate, calcium hydroxide, hydrated alumina (aluminum hydroxide), talc, mica, titanium dioxide, alumina silicate, carbonates, chalk, silicates, glass, metal oxides, graphite, and combinations of any of the foregoing.

Suitable calcium carbonate filler includes products such as Socal® 31, Socal® 312, Socal® U1S1, Socal® UaS2, Socal® N2R, Winnofil® SPM, and Winnofil® SPT available from Solvay Special Chemicals. A calcium carbonate filler can include a combination of precipitated calcium carbonates.

Inorganic filler can be surface treated to provide hydrophobic or hydrophilic surfaces that can facilitate dispersion and compatibility of the inorganic filler with other components of a multiple cure coreactive composition. An inorganic filler can include surface-modified particles such as, for example, surface modified silica. The surface of silica particles can be modified, for example, to be tailor the hydrophobicity or hydrophilicity of the surface of the silica particle. The surface modification can affect the dispensability of the particles, the viscosity, the curing rate, and/or the adhesion.

A multiple cure coreactive composition can comprise an organic filler or a combination of organic filler.

Organic filler can be selected to have a low specific gravity and to be resistant to solvents such as JRF Type I and/or to reduce the density of a coating layer. Suitable organic filler can also have acceptable adhesion to the sulfur-containing polymer matrix. An organic filler can include solid powders or particles, hollow powders or particles, or a combination thereof.

An organic filler can have a specific gravity, for example, less than 1.15, less than 1.1, less than 1.05, less than 1, less than 0.95, less than 0.9, less than 0.8, or less than 0.7. Organic filler can have a specific gravity, for example, within a range from 0.85 to 1.15, within a range from 0.9 to 1.1, within a range from 0.9 to 1.05, or from 0.85 to 1.05.

Organic filler can comprise thermoplastics, thermosets, or a combination thereof. Examples of suitable thermoplastics and thermosets include epoxies, epoxy-amides, ETFE copolymers, nylons, polyethylenes, polypropylenes, polyethylene oxides, polypropylene oxides, polyvinylidene chlorides, polyvinylfluorides, TFE, polyamides, polyimides, ethylene propylenes, perfluorohydrocarbons, fluoroethylenes, polycarbonates, polyetheretherketones, polyetherketones, polyphenylene oxides, polyphenylene sulfides, polystyrenes, polyvinyl chlorides, melamines, polyesters, phenolics, epichlorohydrins, fluorinated hydrocarbons, polycyclics, polybutadienes, polychloroprenes, polyisoprenes, polysulfides, polyurethanes, isobutylene isoprenes, silicones, styrene butadienes, liquid crystal polymers, and combinations of any of the foregoing.

Examples of suitable polyamide 6 and polyamide 12 particles are available from Toray Plastics as grades SP-500, SP-10, TR-1, and TR-2. Suitable polyamide powders are also available from the Arkema Group under the tradename Orgasol®, and from Evonik Industries under the tradename Vestosin®.

An organic filler can include a low density such as a modified, expanded thermoplastic microcapsules. Suitable modified expanded thermoplastic microcapsules can include an exterior coating of a melamine or urea/formaldehyde resin.

A multiple cure coreactive composition can comprise low density microcapsules. A low-density microcapsule can comprise a thermally expandable microcapsule.

Examples of suitable thermoplastic microcapsules include Expancel® microcapsules such as Expancel® DE microspheres available from AkzoNobel. Examples of suitable Expancel™ DE microspheres include Expancel® 920 DE 40 and Expancel® 920 DE 80. Suitable low-density microcapsules are also available from Kureha Corporation.

Low density filler such as low-density microcapsules can be characterized by a specific gravity within a range from 0.01 to 0.09, from 0.04 to 0.09, within a range from 0.04 to 0.08, within a range from 0.01 to 0.07, within a range from 0.02 to 0.06, within a range from 0.03 to 0.05, within a range from 0.05 to 0.09, from 0.06 to 0.09, or within a range from 0.07 to 0.09, wherein the specific gravity is determined according to ASTM D1475. Low density filler such as low-density microcapsules can be characterized by a specific gravity less than 0.1, less than 0.09, less than 0.08, less than 0.07, less than 0.06, less than 0.05, less than 0.04, less than 0.03, or less than 0.02, wherein the specific gravity is determined according to ASTM D1475.

Low density filler such as low-density microcapsules can be characterized by a mean particle diameter from 1 μm to 100 μm and can have a substantially spherical shape. Low density filler such as low-density microcapsules can be characterized, for example, by a mean particle diameter from 10 μm to 100 μm, from 10 μm to 60 μm, from 10 μm to 40 μm, or from 10 μm to 30 μm, as determined according to ASTM D1475.

Low-density filler such as low-density microcapsules can comprise expanded microcapsules or microballoons having a coating of an aminoplast resin such as a melamine resin. Aminoplast resin-coated particles are described, for example, in U.S. Pat. No. 8,993,691. Such microcapsules can be formed by heating a microcapsule comprising a blowing agent surrounded by a thermoplastic shell. Uncoated low-density microcapsules can be reacted with an aminoplast resin such as a urea/formaldehyde resin to provide a coating of a thermoset resin on the outer surface of the particle.

A multiple cure coreactive composition can comprise, for example, from 1 wt % to 90 wt % of low-density filler, from 1 wt % to 60 wt %, from 1 wt % to 40 wt %, from 1 wt % to 20 wt %, from 1 wt % to 10 wt %, or from 1 wt % to 5 wt % of low-density filler, where wt % is based on the total weight of the multiple cure coreactive composition.

A multiple cure coreactive composition can comprise greater than 1 wt % low density filler, greater than 1 wt %, greater than 2 wt %, greater than 3 wt %, greater than 4 wt %, greater than 1 wt %, or greater than 10 wt % low-density filler, where wt % is based on the total weight of the multiple cure coreactive composition.

A multiple cure coreactive composition can comprise from 1 vol % to 90 vol % low-density filler, from 5 vol % to 70 vol %, from 10 vol % to 60 vol %, from 20 vol % to 50 vol %, or from 30 vol % to 40 vol % low density filler, where vol % is based on the total volume of the multiple cure coreactive composition.

A multiple cure coreactive composition can comprise greater than 1 vol % low-density filler, greater than 5 vol %, greater than 10 vol %, greater than 20 vol %, greater than 30 vol %, greater than 40 vol %, greater than 50 vol %, greater than 60 vol %, greater than 70 vol %, or greater than 80 vol % low-density filler, where vol % is based on the total volume of the multiple cure coreactive composition.

A multiple cure coreactive composition can include a conductive filler or a combination of conductive filler. A conductive filler can include electrically conductive filler, semiconductive filler, thermally conductive filler, magnetic filler, EMI/RFI shielding filler, static dissipative filler, electroactive filler, or a combination of any of the foregoing.

A multiple cure coreactive composition can comprise an electrically conductive filler or a combination of electrically conductive filler.

Examples of suitable conductive filler such as electrically conductive filler include metals, metal alloys, conductive oxides, semiconductors, carbon, carbon fiber, and combinations of any of the foregoing.

Other examples of electrically conductive filler include electrically conductive noble metal-based filler such as pure silver; noble metal-plated noble metals such as silver-plated gold; noble metal-plated non-noble metals such as silver plated cooper, nickel or aluminum, for example, silver-plated aluminum core particles or platinum-plated copper particles; noble-metal plated glass, plastic or ceramics such as silver-plated glass microspheres, noble-metal plated aluminum or noble-metal plated plastic microspheres; noble-metal plated mica; and other such noble-metal conductive filler. Non-noble metal-based materials can also be used and include, for example, non-noble metal-plated non-noble metals such as copper-coated iron particles or nickel-plated copper; non-noble metals, e.g., copper, aluminum, nickel, cobalt; non-noble-metal-plated-non-metals, e.g., nickel-plated graphite and non-metal materials such as carbon black and graphite. Combinations of electrically conductive filler and shapes of electrically conductive filler can be used to achieve a desired conductivity, EMI/RFI shielding effectiveness, hardness, and other properties suitable for a particular application.

Organic filler, inorganic filler, and low-density filler can be coated with a metal to provide conductive filler.

An electrically conductive filler can include graphene. Graphene comprises a densely packed honeycomb crystal lattice made of carbon atoms having a thickness equal to the atomic size of one carbon atom, i.e., a monolayer of sp² hybridized carbon atoms arranged in a two-dimensional lattice.

Graphene can comprise graphenic carbon particles. Graphenic carbon particles refer to carbon particles having structures comprising one or more layers of one-atom-thick planar sheets of sp²-bonded carbon atoms that are densely packed in a honeycomb crystal lattice. An average number of stacked layers can be less than 100, for example, less than 50. An average number of stacked layers can be 30 or less, such as 20 or less, 10 or less, or, in some cases, 5 or less. Graphenic carbon particles can be substantially flat, however, at least a portion of the planar sheets may be substantially curved, curled, creased or buckled. Graphenic carbon particles typically do not have a spheroidal or equiaxed morphology.

Filler used to impart electrical conductivity and EMI/RFI shielding effectiveness can be used in combination with graphene.

Electrically conductive non-metal filler, such as carbon nanotubes, carbon fibers such as graphitized carbon fibers, and electrically conductive carbon black, can also be used in multiple cure coreactive compositions in combination with graphene.

Examples of suitable carbonaceous materials for use as conductive filler other than graphene and graphite include, for example, graphitized carbon black, carbon fibers and fibrils, vapor-grown carbon nanofibers, metal coated carbon fibers, carbon nanotubes including single- and multi-walled nanotubes, fullerenes, activated carbon, carbon fibers, expanded graphite, expandable graphite, graphite oxide, hollow carbon spheres, and carbon foams.

A filler can include carbon nanotubes. Suitable carbon nanotubes can be characterized by a thickness or length, for example, from 1 nm to 5,000 nm. Suitable carbon nanotubes can be cylindrical in shape and structurally related to fullerenes. Suitable carbon nanotubes can be open or capped at their ends. Suitable carbon nanotubes can comprise, for example, more than 90 wt %, more than 95 wt %, more than 99 wt %, or more than 99.9 wt % carbon, where wt % is based on the total weight of the carbon nanotube.

A multiple cure coreactive composition can comprise one or more adhesion promoters.

An adhesion promoter can be selected to enhance substrate adhesion, interlayer adhesion, and/or adhesion to filler, reinforcing materials, and/or to other additives.

A multiple cure coreactive composition can comprise an adhesion promoter or combination of adhesion promoters. Adhesion promoters can enhance the adhesion of a coating to an underlying substrate such as a metal, composite, polymeric, or a ceramic surface, or to a coating such as a primer coating or other coating layer. Adhesion promoters can enhance adhesion to filler, to a substrate or a previously deposited layer of the multiple cure coreactive composition.

An adhesion promoter can include a phenolic adhesion promoter, a combination of phenolic adhesion promoters, an organo-functional silane, a combination of organo-functional silanes, or a combination of any of the foregoing. An organo-functional alkoxysilane can be an amine-functional alkoxysilane. The organo group can be selected from, for example, a thiol group, an amine group, an epoxy group, an alkenyl group, an isocyanate group, or a Michael acceptor group.

A phenolic adhesion promoter can comprise a cooked phenolic resin, an un-cooked phenolic resin, or a combination thereof. Examples of suitable adhesion promoters include phenolic resins such as Methylon® phenolic resin, and organosilanes, such as epoxy-, mercapto- or amine-functional silanes, such as Silquest® organosilanes. A cooked phenolic resin refers to a phenolic resin that has been coreacted with a monomer, oligomer, or prepolymer.

A phenolic adhesion promoter can comprise the reaction product of a condensation reaction of a phenolic resin with one or more thiol-terminated polysulfides. Phenolic adhesion promoters can be thiol-terminated.

Examples of suitable phenolic resins include 2-(hydroxymethyl)phenol, (4-hydroxy-1,3-phenylene)dimethanol, (2-hydroxybenzene-1,3,4-triyl) trimethanol, 2-benzyl-6-(hydroxymethyl)phenol, (4-hydroxy-5-((2-hydroxy-5-(hydroxymethyl)cyclohexa-2,4-dien-1-yl)methyl)-1,3-phenylene)dimethanol, (4-hydroxy-5-((2-hydroxy-3,5-bis(hydroxymethyl)cyclohexa-2,4-dien-1-yl)methyl)-1,3-phenylene)dimethanol, and a combination of any of the foregoing.

Suitable phenolic resins can be synthesized by the base-catalyzed reaction of phenol with formaldehyde.

A phenolic adhesion promoter can comprise the reaction product of a condensation reaction of a Methylon® resin, a Varcum® resin, or a Durez® resin available from Durez Corporation with a thiol-terminated polysulfide such as a Thioplast® resin.

Examples of Methylon® resins include Methylon® 75108 (allyl ether of methylol phenol, see U.S. Pat. No. 3,517,082) and Methylon® 75202.

Examples of Varcum® resins include Varcum® 29101, Varcum® 29108, Varcum® 29112, Varcum® 29116, Varcum® 29008, Varcum® 29202, Varcum® 29401, Varcum® 29159, Varcum® 29181, Varcum® 92600, Varcum® 94635, Varcum® 94879, and Varcum® 94917.

An example of a Durez® resin is Durez® 34071.

A multiple cure coreactive composition can comprise an organo-functional alkoxysilane adhesion promoter such as an organo-functional alkoxysilane. An organo-functional alkoxysilane can comprise hydrolyzable groups bonded to a silicon atom and at least one organofunctional group. An organo-functional alkoxysilane can have the structure R¹²—(CH₂)ₙ—Si(—OR)₃₋ₙRₙ, where R¹³ is an organofunctional group, n is 0, 1, or 2, and R is alkyl such as methyl or ethyl. Examples of organofunctional groups include epoxy, amino, methacryloxy, or sulfide groups. An organo-functional alkoxysilane can be a dipodal alkoxysilane having two or more alkoxysilane groups, a functional dipodal alkoxysilane, a non-functional dipodal alkoxysilane or a combination of any of the foregoing. An organofunctional alkoxysilane can be a combination of a monoalkoxysilane and a dipodal alkoxysilane. For amino functional alkoxysilanes, R¹³ can be —NH₂.

Examples of suitable amino-functional alkoxysilanes under the Silquest® tradename include Silquest® A-1100 (γ-aminopropyltriethoxysilane), Silquest® A-1108 (γ-aminopropylsilsesquioxane), Silquest® A-1110 (γ-aminopropyltrimethoxysilane), Silquest® 1120 (N-β-(aminoethyl)-γ-aminopropyltrimethoxysilane), Silquest® 1128 (benzylamino-silane), Silquest® A-1130 (triaminofunctional silane), Silquest® Y-11699 (bis-(γ-triethoxysilylpropyl)amine), Silquest® A-1170 (bis-(γ-trimethoxysilylpropyl)amine), Silquest® A-1387 (polyazamide), Silquest® Y-19139 (ethoxy based polyazamide), and Silquest® A-2120 (N-β-(aminoethyl)-γ-aminopropylmethyldimethoxysilane).

Suitable amine-functional alkoxysilanes are commercially available, for example, from Gelest Inc, from Dow Corning Corporation, and Momentive.

An adhesion promoter can be a copolymerizable adhesion promoter. Copolymerizable adhesion promoters include adhesion promoters that have one or more functional groups reactive with one or more of the coreactants.

A multiple cure coreactive composition can comprise, for example, from 1 wt % to 16 wt % of an adhesion promoter, from 3 wt % to 14 wt %, from 5 wt % to 12 wt %, or from 7 wt % to 10 wt % of an adhesion promoter or combination of adhesion promoters, where wt % is based on the total weight of the multiple cure coreactive composition.

A multiple cure coreactive composition can comprise less than 16 wt % of an adhesion promoter, less than 14 wt %, less than 12 wt %, less than 10 wt %, less than 8 wt %, less than 6 wt %, less than 4 wt % or less than 2 wt % of an adhesion promoter or combination of adhesion promoters, where wt % is based on the total weight of the multiple cure coreactive composition.

A multiple cure coreactive composition can comprise a reactive diluent or combination of reactive diluents.

Reactive diluents can also be used to modify the rheological properties of a multiple cure coreactive composition.

Unlike rheology modifiers, a reactive diluent is capable of reacting with a coreactant with the terminal groups or with pendent functional groups.

A reactive diluent can be used to reduce the viscosity of the multiple cure coreactive composition. A reactive diluent can be a low molecular weight compound having at least one functional group capable of reacting with at least one of the major reactants of the multiple cure coreactive composition and become part of the cross-linked network. A reactive diluent can have, for example, one functional group, or two functional group. A reactive dilute can be used to control the viscosity of a multiple cure coreactive composition or improve the wetting of filler in a multiple cure coreactive composition.

For example, a multiple cure coreactive composition can comprise a hydroxyl-functional vinyl ether or combination of hydroxyl-functional vinyl ethers.

A multiple cure coreactive composition can comprise one or more rheology modifiers.

A rheology modifier is distinguished from other reactants and additives that influence the rheological properties of a multiple cure coreactive composition. For example, the molecular weight of the coreactants, the backbone chemistry of the prepolymers, the amount of filler, and/or the type of filler can influence the rheological properties of a multiple cure coreactive composition.

Rheology modifiers can be included to adjust the viscosity of the multiple cure coreactive composition and to facilitate application.

Examples of suitable rheology modifiers include a combination of phthalates, terephthalic, isophthalic, hydrogenated terphenyls, quaterphenyls and higher or polyphenyls, phthalate esters, chlorinated paraffins, modified polyphenyl, tung oil, benzoates, dibenzoates, thermoplastic polyurethane plasticizers, phthalate esters, naphthalene sulfonate, trimellitates, adipates, sebacates, maleates, sulfonamides, organophosphates, polybutene, butyl acetate, butyl cellosolve, butyl carbitol acetate, dipentene, tributyl phosphate, hexadecanol, diallyl phthalate, sucrose acetate isobutyrate, epoxy ester of iso-octyl tallate, benzophenone and combinations of any of the foregoing.

A multiple cure coreactive composition can comprise from 0.5 wt % to 7 wt % of a plasticizer or combination of plasticizers from 1 wt % to 6 wt %, from 2 wt % to 5 wt % or from 2 wt % to 4 wt % of a plasticizer or combination of plasticizers, where wt % is based on the total weight of the multiple cure coreactive composition. A multiple cure coreactive composition can comprise less than 8 wt % plasticizer, less than 6 wt %, less than 4 wt %, or less than 2 wt % of a plasticizer or combination of plasticizers, where wt % is based on the total weight of the multiple cure coreactive composition.

A multiple cure coreactive composition can comprise one or more colorants.

A multiple cure coreactive composition can comprise pigments, dyes, or a combination thereof. Although colorants may not be suitable for use in actinic radiation-curable multiple cure coreactive compositions to the extent that the colorants absorb some or all of incident actinic radiation, colorants can be used in multiple cure coreactive compositions that are not curable using actinic radiation.

Examples of suitable inorganic pigments include metal-containing inorganic pigments such as those containing cadmium, carbon, chromium, cobalt, copper, iron oxide, lead, mercury, titanium, tungsten, and zinc. Examples include ultramarine blue, ultramarine violet, reduced tungsten oxide, cobalt aluminate, cobalt phosphate, manganese ammonium pyrophosphate and/or metal-free inorganic pigments. Inorganic pigment nanoparticles comprise ultramarine blue, ultramarine violet, Prussian blue, cobalt blue and/or reduced tungsten oxide. Examples of specific organic pigments include indanthrone, quinacridone, phthalocyanine blue, copper phthalocyanine blue, and perylene anthraquinone.

Additional examples of suitable pigments include iron oxide pigments, in all shades of yellow, brown, red and black; in all their physical forms and grain categories; titanium oxide pigments in all the different inorganic surface treatments; chromium oxide pigments also co-precipitated with nickel and nickel titanates; black pigments from organic combustion (e.g., carbon black); blue and green pigments derived from copper phthalocyanine, also chlorinated and brominated, in the various alpha, beta and epsilon crystalline forms; yellow pigments derived from lead sulphochromate; yellow pigments derived from lead bismuth vanadate; orange pigments derived from lead sulphochromate molybdate; yellow pigments of an organic nature based on arylamides; orange pigments of an organic nature based on naphthol; orange pigments of an organic nature based on diketo-pyrrolo-pyrrole; red pigments based on manganese salts of azo dyes; red pigments based on manganese salts of beta-oxynaphthoic acid; red organic quinacridone pigments; and red organic anthraquinone pigments.

A colorant can comprise TiO₂. A multiple cure coreactive composition can comprise, for example, from 1 wt % to 30 wt % TiO₂, from 5 wt % to 25 wt %, or from 10 wt % to 20 wt % TiO₂, where wt % is based on the total weight of the multiple cure coreactive composition. A multiple cure coreactive composition can comprise, for example, greater than 1 wt % TiO₂, greater than 5 wt %, greater than 10 wt %, greater than 15 wt %, greater than 20 wt %, or greater than 25 wt % TiO₂, where wt % is based on the total weight of the multiple cure coreactive composition. A multiple cure coreactive composition can comprise, for example, less than 30 wt % TiO₂, less than 25 wt %, less than 20 wt %, less than 15 wt %, or less than 10 TiO₂, where wt % is based on the total weight of the multiple cure coreactive composition. The TiO₂ can comprise a silica coating. The TiO₂ can have a mean particle size, for example, from 200 mm to 600 mm, such as from 200 mm to 500 mm.

A multiple cure coreactive composition can comprise a fire retardant or combination of fire retardants. A fire retardant can include an inorganic fire retardant, an organic fire retardant, or a combination thereof.

Examples of suitable inorganic fire retardants include aluminum hydroxide, magnesium hydroxide, zinc borate, antimony oxides, hydromagnesite, aluminum trihydroxide (ATH), calcium phosphate, titanium oxide, zinc oxide, magnesium carbonate, barium sulfate, barium borate, kaolinite, silica, antimony oxides, and combinations of any of the foregoing.

Examples of suitable organic fire retardants include halocarbons, halogenated esters, halogenated ethers, chlorinated and/or brominated flame retardants, halogen free compounds such as organophosphorus compounds, organonitrogen compounds, and combinations of any of the foregoing.

A multiple cure coreactive composition can comprise a thermal stabilizer or combination of thermal stabilizers. Examples of suitable thermal stabilizers include sterically hindered phenolic antioxidants such as pentaerythrityl tetrakis[3-(3,5-di-tert-butyl-4-hydroxyphenyl)propionate] (Irganox® 1010, BASF), triethylene glycol bis[3-(3-tert-butyl-4-hydroxy-5-methylphenyl)propionate] (Irganox® 245, BASF), 3,3′-bis[3-(3,5-di-tert-butyl-4-hydroxyphenyl)propionohydrazide] (Irganox® MD 1024, BASF), hexamethylene glycol bis[3-(3,5-di-tert-butyl-4-hydroxyphenyl)propionate] (Irganox® 259, BASF), and 3,5-di-tert-butyl-4-hydroxytoluene (Lowinox BHT, Chemtura).

A multiple cure coreactive composition can further comprise a shelf stabilizer, a thermal stabilizer, a UV stabilizer, a UV absorber, a hindered amine light stabilizer, a dichroic material, a photochromic material, a polymerization moderator, a monomer having a single ethylenically unsaturated radially polymerizable group, a monomer having two or more ethylenically unsaturated radically polymerizable groups, a pigment, a dye, or a combination of any of the foregoing.

A multiple cure coreactive composition provided by the present disclosure can comprise a shelf stabilizer or a combination of shelf stabilizers. Examples of suitable shelf stabilizers include 4-methoxyphenol, hydroquinone, pyrogallol, butylated hydroxytoluene (BHT), and 4-tert-butylcatechol.

A multiple cure coreactive composition provided by the present disclosure can comprise a thermal stabilizer or a combination of thermal stabilizers.

A multiple cure coreactive composition provided by the present disclosure can comprise a UV stabilizer or a combination of UV stabilizers. UV stabilizers include UV absorbers and hindered amine light stabilizers. Examples of suitable UV stabilizers include products under the tradenames Cyasorb® (Solvay), Uvinul® (BASF), and Tinuvin® (BASF).

Methods provided by the present disclosure comprise fabricating a three-dimensional object using a multiple cure coreactive composition provided by the present disclosure.

To fabricate a three-dimensional object, the coreactants can be combined and mixed to provide a multiple cure coreactive composition.

After mixing, the multiple cure coreactive composition can be extruded through a nozzle to provide an extrudate.

The extrudate can be deposited onto a substrate or a previously deposited layer to fabricate a three-dimensional object using a computer-controlled system.

After the coreactants are combined and mixed at least one combination of coreactants begins to react resulting in an increase in the viscosity of the multiple cure coreactive composition. For example, between the time that the coreactants are first mixed to the time the multiple cure coreactive composition is extruded through a nozzle the viscosity of the multiple cure coreactive composition can increase by more than 1%, more than 2%, more than 5%, more than 10%, more than 20%, more than 30%, or more than 50%.

The multiple cure coreactive composition can be partially cured, but not fully cured, at the time the multiple cure coreactive composition is being extruded through the nozzle.

During maxing, extrusion, and deposition, the multiple cure coreactive composition can have a temperature, for example, less than 30° C., less than 28° C., less than 26° C., less than 24° C., or less than 22° C.

After the multiple cure coreactive composition is deposited to form a three-dimensional object, the three-dimensional object can be heated to thermally cure the second combination of coreactants. For example, to fully cure the three-dimensional object, the object can be exposed to a temperature for example, greater than 30° C., greater than 50° C., to greater than 70° C. for more than 6 hours, more than 12 hours, more than 24 hours, more than 36 hours, or more than 48 hours.

One or more coreactants can be provided as components that are combined and mixed with other components comprising one or more coreactants.

A component refers to a composition comprising at least one coreactant and other materials such as one or more additives. The components can be formulated such that the initial viscosity of each of the components to be combined and mixed is within +/−20% at a temperature of 25° C. Having a similar viscosity will facilitate the ability of the components to form a homogenous multiple cure coreactive composition.

Each of the coreactants can be delivered to the mixer as a separate component or two or more coreactants can be provided as a component.

Whether the coreactants are delivered separately or combined can depend on the curing chemistries involved.

A multiple cure coreactive composition such as a multiple cure coreactive composition provided by the present disclosure can be used to fabricate parts using coreactive three-dimensional printing.

A three-dimensional printing apparatus for fabricating a part can comprise one or more pumps, one or more mixers, one or more nozzles, one or more material reservoirs, and automated control electronics.

A three-dimensional printing apparatus can comprise pressure controls, extrusion dies, coextrusion dies, coating applicators, temperature control elements, elements for irradiating a multiple cure coreactive composition, or combinations of any of the foregoing.

A three-dimensional printing apparatus can comprise an apparatus such as a gantry for moving a nozzle with respect to a surface. The apparatus can be controlled by a processor.

A multiple cure coreactive composition can be deposited using any suitable coreactive three-dimensional printing equipment. The selection of suitable three-dimensional printing can depend on a number of factors including the deposition volume, the viscosity of the coreactive composition, the deposition rate, the gel time of the coreactive compounds, and the complexity of the part being fabricated. Each of the two or more reactive components can be introduced into an independent pump and injected into a mixer to combine and mix the two reactive components. A nozzle can be coupled to the mixer and the mixed multiple cure coreactive composition can be pushed under pressure or extruded through the nozzle.

A pump can be, for example, a positive displacement pump, a syringe pump, a piston pump, or a progressive cavity pump. The two pumps delivering the two reactive components can be placed in parallel or placed in series. A suitable pump can be capable of pushing a liquid or viscous liquid through a nozzle orifice. This process can also be referred to as extrusion. A reactive component can be introduced into the mixer using two pumps in series.

For example, the two or more coreactive components can be deposited by dispensing materials through a disposable nozzle attached to a progressive cavity two-component system where the coreactive components are mixed in-line. A two-component system can comprise, for example, two progressive cavity pumps that separately dose reactants into a disposable static mixer dispenser or into a dynamic mixer. Other suitable pumps include positive displacement pumps, syringe pumps, piston pumps, and progressive cavity pumps. After mixing the two or more coreactive components to form a multiple cure coreactive composition, the multiple cure coreactive composition is formed into an extrudate as it is forced under pressure through one or more dies and/or one or nozzles to be deposited onto a base to provide an initial layer of a vehicle part, and successive layers can be deposited adjacent a previously deposited layer. The deposition system can be positioned orthogonal to the base, but also may be set at any suitable angle to form the extrudate such that the extrudate and deposition system form an obtuse angle with the extrudate being parallel to the base. The extrudate refers to the multiple cure coreactive composition after the coreactive components are mixed, for example, in a static mixer or in a dynamic mixer. The extrudate can be shaped upon passing through a die and/or nozzle.

The base, the deposition system, or both the base and the deposition system may be moved to build up a three-dimensional article. The motion can be made in a predetermined manner, which may be accomplished using any suitable CAD/CAM method and apparatus such as robotics and/or computerize machine tool interfaces.

An extrudate may be dispensed continuously or intermittently to form an initial layer and successive layers. For intermittent deposition, a deposition system may interface with a switch to shut off the pumps, such as the progressive cavity pumps and interrupt the flow of one or more of the coreactive components and/or the multiple cure coreactive composition.

A three-dimensional printing apparatus can include an in-line static and/or dynamic mixer as well as separate pressurized pumping compartments to hold the at least two coreactive components and feed the coreactive components into the static and/or dynamic mixer. A mixer such as an active mixer can comprise a variable speed central impeller having high shear blades within a nozzle. A range of nozzles may be used which have a minimum dimension, for example, from 0.2 mm to 100 mm, from 0.5 mm to 75 mm, from 1 mm to 50 mm, or from 5 mm to 25 mm. A nozzle can have a minimum dimension, for example, greater than 1 mm, greater than 5 mm, greater than 10 mm, greater than 20 mm, greater than 30 mm, greater than 40 mm, greater than 50 mm, greater than 60 mm, greater than 70 mm, greater than 80 mm, or greater than 90 mm. A nozzle can have a minimum dimension, for example, less than 100 mm, less than 90 mm, less than 80 mm, less than 70 mm, less than 60 mm, less than 50 mm, less than 40 mm, less than 30 mm, less than 20 mm, less than 10 mm, or less than 5 mm. A nozzle can have any suitable cross-sectional dimension such as, for example, round, spherical, oval, rectangular, square, trapezoidal, triangular, planar, or other suitable shape.

A range of static and/or dynamic mixing nozzles may be used which have, for example, an exit orifice dimension from 0.6 mm to 2.5 mm, and a length from 30 mm to 150 mm. For example, an exit orifice diameter can be from 0.2 mm to 4.0 mm, from 0.4 mm to 3.0 mm, from 0.6 mm to 2.5 mm, from 0.8 mm to 2 mm, or from 1.0 mm to 1.6 mm. A static mixer and/or dynamic can have a length, for example, from 10 mm to 200 mm, from 20 mm to 175 mm, from 30 mm to 150 mm, or from 50 mm to 100 mm. A mixing nozzle can include a static and/or dynamic mixing section and a dispensing section coupled to the static and/or dynamic mixing section. The static and/or dynamic mixing section can be configured to combine and mix the coreactive materials. The dispensing section can be, for example, a straight tube having any of the above orifice diameters. The length of the dispensing section can be configured to provide a region in which the coreactive compounds can begin to react and build viscosity before the multiple cure coreactive composition is deposited on the article. The length of the dispensing section can be selected, for example, based on the speed of deposition, the rate of reaction of the co-reactants, and the desired viscosity.

A multiple cure coreactive composition can have a residence time in the static and/or dynamic mixing nozzle, for example, from 0.25 seconds to 5 seconds, from 0.3 seconds to 4 seconds, from 0.5 seconds to 3 seconds, or from 1 seconds to 3 seconds. Other residence times can be used as appropriate based on the curing chemistries and curing rates of a multiple cure coreactive composition.

In general, a suitable residence time is less than the gel time of the coreactive composition.

A three-dimensional printing apparatus can deposit a multiple cure coreactive composition at a volume flow rate, for example, from 0.1 mL/min to 20,000 mL/min, such as from 1 mL/min to 12,000 mL/min, from 5 mL/min to 8,000 mL/min, or from 10 mL/min to 6,000 mL/min. A multiple cure coreactive composition can be deposited at a volume flow rate, for example, greater than 0.1 mL/min, greater than 1 mL/min, greater than 10 mL/min, greater than 100 mL/min, greater than 1,000 mL/min, or greater than 10,000 mL/min. A three-dimensional printing apparatus can deposit a multiple cure coreactive composition can be deposited at a volume flow rate, for example, less than 20,000 mL/min, less than 10,000 mL/min, less than 1,000 mL/min, less than 100 mL/min, less than 10 mL/min, or less than 1 mL/min. The volume flow rate can depend, for example, on the viscosity of a multiple cure coreactive composition, the extrusion pressure, the nozzle diameter, and the gel time of the multiple cure coreactive compounds.

A three-dimensional printing apparatus can deposit a multiple cure coreactive composition at a deposition speed, for example, from 1 mm/sec to 400 mm/sec, such as from 5 mm/sec to 300 mm/sec, from 10 mm/sec to 200 mm/sec, or from 15 mm/sec to 150 mm/sec. A three-dimensional printing apparatus can deposit a multiple cure coreactive composition, for example, at greater than 1 mm/sec, greater than 10 mm/sec, or greater than 100 mm/sec. A three-dimensional printing apparatus can deposit a multiple cure coreactive composition, for example, at less than 400 mm/sec, less than 100 mm/sec, or less than 10 mm/sec. The deposition speed can depend, for example, on the viscosity of the multiple cure coreactive composition, the extrusion pressure, the nozzle diameter, and the gel time of the coreactive compounds. The deposition speed refers to the speed at which a nozzle used to extrude a multiple cure coreactive composition moves with respect to a surface onto which the multiple cure coreactive composition is being deposited.

A static and/or dynamic mixing nozzle can be heated or cooled to control, for example, the rate of reaction between the coreactive compounds and/or the viscosity of the coreactive compounds. An orifice of a deposition nozzle can have any suitable shape and dimensions. A three-dimensional printing apparatus can comprise multiple deposition nozzles. The nozzles can have a fixed orifice dimension and shape, or the nozzle orifice can be controllably adjusted. The mixer and/or the nozzle may be cooled to control an exotherm generated by the reaction of the coreactive compounds.

The speed at which the multiple cure coreactive composition reacts to form the thermoset polymeric matrix can be determined and/or controlled by the selection of the reactive functional groups of the coreactive compounds. The reaction speed can also be determined by factors that lower the activation energy of the reaction such as heat and/or catalysts.

Gel times can be reflected in the gel time of a multiple cure coreactive composition. A fast curing chemistry refers to a chemistry in which the co-reactive compounds have a gel time less than 5 minutes, less than 4 minutes, less than 3 minutes, less than 2 minutes, less than 1 minute, less than 45 seconds, less than 30 seconds, less than 15 seconds, or less than 5 seconds. Coreactive compounds can have a gel time, for example, from 0.1 seconds to 5 minutes, from 0.2 seconds to 3 minutes, from 0.5 seconds to 2 minutes, from 1 second to 1 minute, or from 2 seconds to 40 seconds. Gel time is the time following mixing the coreactive compounds when the coreactive compounds are no longer stirrable by hand.

A multiple cure coreactive composition having a high viscosity can have a long gel time. Because of the high viscosity the deposited multiple cure coreactive composition can retain an intended shape following deposition and the ability to retain the intended shape may not depend as much on the curing to increase the viscosity. For multiple cure coreactive compositions having a high viscosity, the gel time can be, for example, greater than 0.5 hours, greater than 1 hour, greater than 2 hours, greater than 5 hours, or greater than 10 hours. For example, for a multiple cure coreactive composition having a high viscosity, the gel time can be from 1 to 10 hours, from 1.5 to 8 hours, from 2 hours to 6 hours, or from 3 hours to 5 hours.

A multiple cure coreactive composition provided by the present disclosure can be used to fabricate any suitable part. Examples of parts include vehicle parts such as aerospace vehicle parts, architectural parts, construction parts, electronic parts, furniture, medical devices, portable devices, telecommunications devices, athletic equipment, apparel, and toys.

Parts such as vehicle parts including automotive vehicle parts and aerospace vehicle parts made using coreactive three-dimensional printing methods provided by the present disclosure are included within the scope of the present invention.

Coreactive three-dimensional printing methods provided by the present disclosure can be used to fabricate internal and external vehicle parts such as motor vehicle parts, railed vehicle parts, aerospace vehicle parts, military vehicle parts, and watercraft parts.

Any suitable vehicle part can be fabricated using the materials and three-dimensional printing methods provided by the present disclosure.

A vehicle part can be a new part or a replacement part.

The term “vehicle” is used in its broadest sense and includes all types of aircraft, spacecraft, watercraft, and ground vehicles. For example, a vehicle can include aircraft such as airplanes including private aircraft, and small, medium, or large commercial passenger, freight, and military aircraft; helicopters, including private, commercial, and military helicopters; aerospace vehicles including, rockets and other spacecraft. A vehicle can include a ground vehicle such as, for example, trailers, cars, trucks, buses, vans, construction vehicles, golf carts, motorcycles, bicycles, scooters, trains, and railroad cars. A vehicle can also include watercraft such as, for example, ships, boats, and hovercraft.

A vehicle part can be, for example, part for a motor vehicle, including automobile, truck, bus, van, motorcycles, scooters, and recreational motor vehicles; railed vehicles including trains and trams; bicycles; aerospace vehicles including airplanes, rockets, spacecraft, jets, and helicopters; military vehicles including jeeps, transports, combat support vehicles, personnel carriers, infantry fighting vehicles, mine-protected vehicles, light armored vehicles, light utility vehicles, and military trucks; and watercraft including ships, boats, and recreational watercraft.

Examples of aviation vehicles include F/A-18 jet or related aircraft such as the F/A-18E Super Hornet and F/A-18F; in the Boeing 787 Dreamliner, 737, 747, 717 passenger jet aircraft, a related aircraft (produced by Boeing Commercial Airplanes); in the V-22 Osprey; VH-92, S-92, and related aircraft (produced by NAVAIR and Sikorsky); in the G650, G600, G550, G500, G450, and related aircraft (produced by Gulfstream); and in the A350, A320, A330, and related aircraft (produced by Airbus). Methods provided by the present disclosure can be used in any suitable commercial, military, or general aviation aircraft such as, for example, those produced by Bombardier Inc. and/or Bombardier Aerospace such as the Canadair Regional Jet (CRJ) and related aircraft; produced by Lockheed Martin such as the F-22 Raptor, the F-35 Lightning, and related aircraft; produced by Northrop Grumman such as the B-2 Spirit and related aircraft; produced by Pilatus Aircraft Ltd.; produced by Eclipse Aviation Corporation; or produced by Eclipse Aerospace (Kestrel Aircraft).

A vehicle part can be an interior vehicle part or an exterior vehicle part.

A vehicle can comprise a motor vehicle and the motor vehicle part can comprise a hood, door, side panel, bumper, roof, wheel well, dashboard, seat, trunk, handle, floor, chassis, cabin, chassis, cargo bed, steering wheel, fuel tank, engine block, trim, bumper, and/or a battery casing.

A vehicle can comprise a railed vehicle and the railed vehicle part can comprise an engine and/or a rail car.

A vehicle can comprise an aerospace vehicle and the aerospace part can comprise a cockpit, fuselage, wing, aileron, tail, door, seat, interior panel, fuel tank, interior panel, flooring, and/or frame.

A vehicle can comprise a military vehicle and the military vehicle part can comprise a hood, door, side panel, bumper, roof, wheel well, dashboard, seat, trunk, handle, floor, chassis, cabin, chassis, cargo bed, steering wheel, fuel tank, engine block, trim, bumper, a mount, a turret, an undercarriage, and/or a battery casing.

A vehicle comprises a watercraft and the watercraft part can comprise a hull, an engine mount, a seat, a handle, a chassis, a battery, a battery mount, a fuel tank, an interior accessory, flooring, and/or paneling.

Vehicle parts fabricated using the materials and methods according to the present invention can have properties for the intended purpose.

For example, an automotive part can be designed have a light weight.

An external part for military vehicle can be designed to have a high impact strength.

A part for a commercial aerospace vehicle can be designed to have a light weight and/or to be static dissipative.

An external part for a military aircraft can be designed to exhibit RFI/EMI shielding properties.

Coreactive three-dimensional printing methods can be adapted to fabricate custom designed vehicle parts, replacement parts, upgraded parts, specialty parts, and/or high-performance parts rapidly and cost-effectively in low volume production.

After a part is fabricated, the three-dimensionally printed part can be subjected to one or more secondary operations.

Examples of secondary operations include smoothing, coating, painting, treating, laminating, and sealing.

A surface of a part can be smoothed, for example, by sanding or blasting.

A surface of part can be coated with one or more coatings. A coating can impart desired property to a surface such as corrosion resistance, adhesion between the surface and an overlying coating, interlayer adhesion, solvent resistance, static dissipation, electrical conductivity, aesthetics, RFI/EMI shielding, and/or scratch resistance.

A surface of a part can be painted with one or more layers of paint.

A multiple cure coreactive composition provided by the present disclosure can be used as a rubber replacement.

Examples of elastomeric articles that can be fabricated using the elastomeric material include shoes, wheel treads, gaskets, gloves, non-slip mats, flexible hinges, and generally most products where elastomers are currently already in use.

Other examples include interior vehicle parts such as interior automotive parts and interior aircraft parts.

Suitable elastomeric products include those in which high tensile strength, higher tensile elongation, and high hardness are desired, and where a high filler content is not appropriate.

Examples of elastomeric articles that can be fabricated using multiple cure coreactive compositions provided by the present disclosure include seals, sealants, grommets, gaskets, washers, bushings, flanges, insulation, shoe soles, boots, footwear, handles, bumpers, shock absorbers, matting, tires, supports, automotive parts, vehicle parts, aerospace parts, marine parts, athletic equipment, toys, novelty items, and casings.

Sealing components can be used to seal the interface from liquids and solvents, can be used to accommodate non-planarity between opposing surfaces, and/or can conform to changes in the relative position of the opposing surfaces during use. Examples of sealing components include gaskets, shims, washers, grommets, O-rings, spacers, packing, cushions, mating material, flanges, and bushings.

Coreactive three-dimensional printing methods provided by the present disclosure can be used to fabricate a seal cap. Seal caps provided by the present disclosure can be used to seal fasteners. Examples of fasteners include anchors, cap screws, cotter pins, eyebolts, nuts, rivets, self-clinching fasteners, self-tapping screws, sockets, thread cutting screws, tum and wing screws, weld screws, bent bolts, captive panel fasteners, machine screws, retaining rings, screwdriver insert bits, self-drilling screws, SEMS, spring nuts, thread rolling screws, and washers.

A fastener can be a fastener on the surface of a vehicle including, for example, motor vehicles, aerospace vehicles, automobiles, trucks, buses, vans, motorcycles, scooters, recreational motor vehicles; railed vehicles trains, trams, bicycles, airplanes, rockets, spacecraft, jets, helicopters, military vehicles including jeeps, transports, combat support vehicles, personnel carriers, infantry fighting vehicles, mine-protected vehicles, light armored vehicles, light utility vehicles, military trucks, watercraft including ships, boats, and recreational watercraft. The term vehicle is used in its broadest sense and includes all types of aircraft, spacecraft, watercraft, and ground vehicles. For example, a vehicle can include aircraft such as airplanes including private aircraft, and small, medium, or large commercial passenger, freight, and military aircraft; helicopters, including private, commercial, and military helicopters; aerospace vehicles including rockets and other spacecraft. A vehicle can include a ground vehicle such as, for example, trailers, cars, trucks, buses, vans, construction vehicles, golf carts, motorcycles, bicycles, trains, and railroad cars. A vehicle can also include watercraft such as, for example, ships, boats, and hovercraft.

A multiple cure coreactive composition provided by the present disclosure can be used to fabricate a part in the form of a layer or more than one layer. For example, the layer can be a coating, a sealant layer, an interface, or an overlayer. In other words, a part includes substantially two-dimensional parts as well as three-dimensional parts. A sealant layer can comprise a vehicle sealant layer such as an aerospace sealant layer. The sealant layer, for example, can be in the form of a sealing component such as a gasket or can be in the form of a sheet of sealant material applied to a surface or a portion of a surface.

### EXAMPLES

Embodiments provided by the present disclosure are further illustrated by reference to the following examples, which describe multiple cure coreactive compositions and methods of using the multiple cure coreactive compositions to fabricate thermoset objects by coreactive three-dimensional printing. It will be apparent to those skilled in the art that many modifications, both to materials, and methods, may be practiced without departing from the scope of the disclosure.

### Example 1

### Thia-Michael Addition/Aza-Michael Addition Multiple Cure Coreactive Composition

Gel times of an aza-Michael addition/thia-Michael addition two-component multiple cure coreactive composition were tested as a function of the amine/thiol ratio in the Michael donor component. The thiol crosslinker was Permapol® P-3.1e, a thiol-functional polythioether prepolymer available from PPG Industries, Inc., and the polyamine crosslinker was Jeffamine® D-400, a polyoxypropylenediamine available from Huntsman Corporation. The polyfunctional Michael acceptor was a tetra-functional acrylate, Miramer® M4004, available from Miwon Specialty Chemicals. For each multiple cure coreactive composition, the amount of Miramer® M4004 was adjusted to maintain a 1:1 Michael donor to Michael acceptor equivalents ratio. The Permapol®/Jeffamine® Michael donor mixture was first prepared and stirred thoroughly by hand. Miramer® M4004 was then gently poured on top to minimize premature mixing. The timer was initiated as soon as the mass of Miramer® M4004 equaled the target mass to achieve a 1:1 equivalents ratio and upon initiating the timer the mixture was mixed and stirred by hand using a wooden stick. Gel time was defined as the time at which the stick broke while stirring by hand.

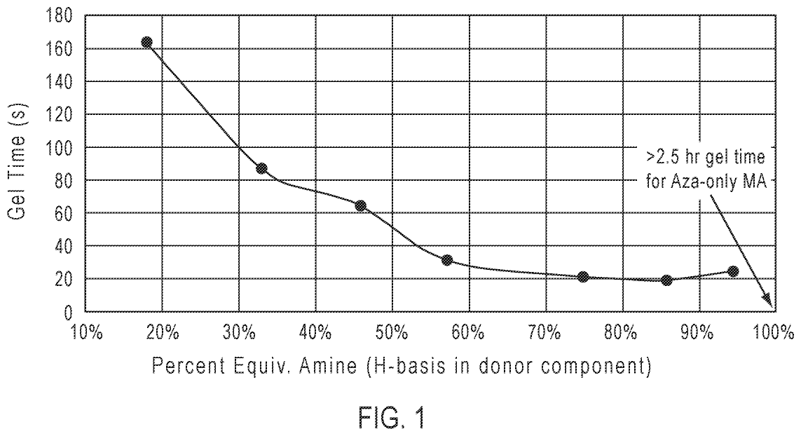

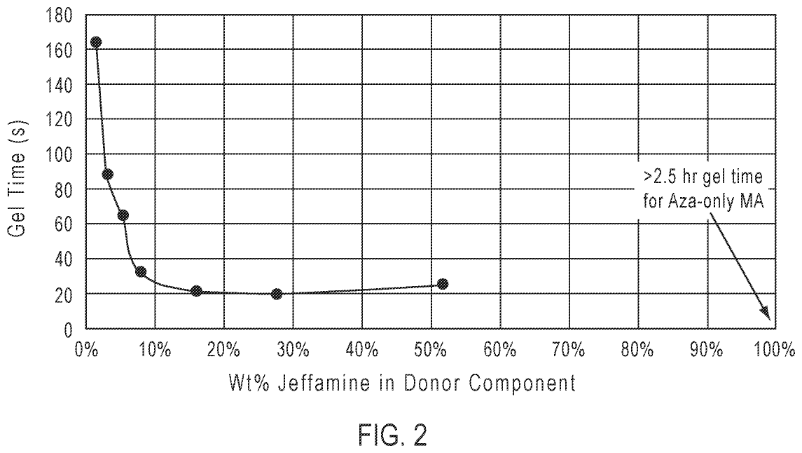

As a control composition, the aza-Michael addition reaction between Jeffamine® D-400 and Miramer® M4004 was monitored and exhibited a gel time greater than 2.5 hours. The gel time of thia/Michael addition reaction between Permapol® P-3.1e and Jeffamine® D-400 was adjusted to between 3 minutes and 20 seconds by varying the ratio of the thiol to amine equivalents ratio in the Michael donor mixture. The results are shown in FIG. 1 and FIG. 2.

### Example 2

### 3D-Printed Aza-Michael Addition/Thia-Michael Addition Multiple Cure Coreactive Composition

An aza-Michael addition/thia-Michael addition multiple cure coreactive composition was prepared by combining a Michael acceptor component and a Michael donor component.

The constituents of the Michal acceptor component are provided in Table 3.

TABLE 3
Michael acceptor component.

| Constituent | Material | Weight % |
|---|---|---|
| Miramer ® PU2100 | Aliphatic difunctional acrylate | 88 |
| Miramer ® MU9800 | Aliphatic multifunctional acrylate | 5 |
| Cabosil ® TS-720 | Fumed silica | 7 |

From Table 3, Miramer® PU2100, Miramer® MU9800 and Cabosil® TS-720 were added to a Max 300 L DAC cup and dispersed using a SpeedMixer®. The Michael acceptor component was transferred from the DAC cup to an Optimum® cartridge using a FlackTek SpeedDisc®, which was connected to one inlet of a ViscoTec 2k extruder mounted to a Lutzbot® Taz 6 3D printer gantry.

The constituents of the Michal donor component are provided in Table 4.

TABLE 4
Michael donor component.

| Constituent | Material | Weight % |
|---|---|---|
| Jeffamine ® D400 | Difunctional Polyamine | 10 |
| Permapol ® P-3.1e | Polythiol | 80 |
| | functionality 2.3 | |

From Table 4, Jeffamine® D400 and Permapol® P-3.1e were added to a Max 300 L DAC cup and mixed using SpeedMixer®. The Michael donor component was transferred from the DAC cup to a separate Optimum® cartridge, which was connected to the other inlet of a ViscoTec 2k extruder mounted to a Lutzbot® Taz 6 3D printer gantry.

The Michael acceptor and Michael donor components were combined and mixed by pumping the contents of the two cartridges through a static mixer to provide a multiple cure coreactive composition and extruded with a Michael donor to Michael acceptor volume mix ratio of 1.5:1 and 3D printed into several objects including ASTM D638 Type IV dogbones for tensile tests. Dogbones consisting of 4 sequential overlying layers of the multiple cure coreactive composition were printed. The extrusion rate was approximately 3.0 mL/min and the average print head movement speed was about 2,400 mm/min.

The gel time of the extruded multiple cure coreactive composition was measured to be approximately 105 sec.

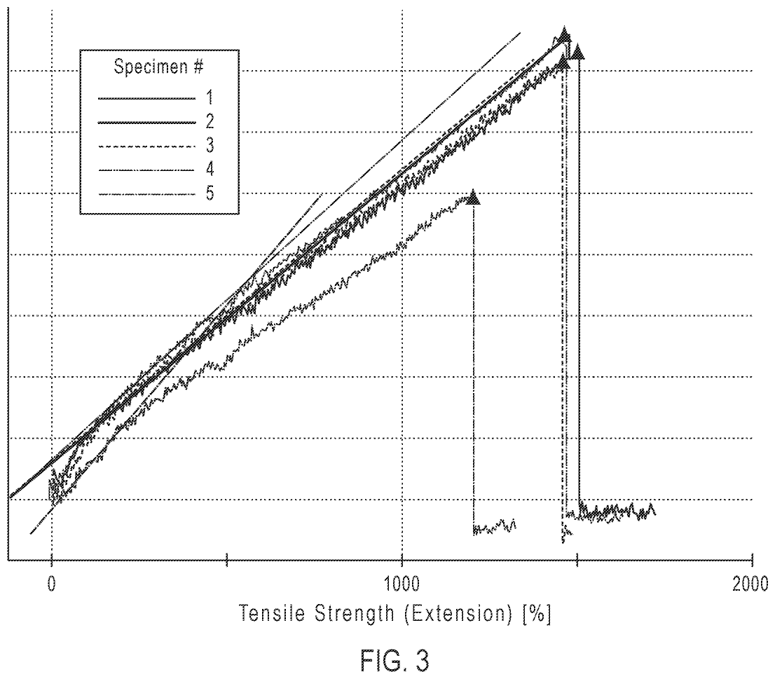

The tensile strain for 5 dogbones is shown in FIG. 3.

### Example 3

### Aza-Michael Addition/Epoxy-Amine Multiple Cure Coreactive Composition

An aza-Michael addition/epoxy-amine multiple cure coreactive composition was prepared by combining a Michael acceptor component and an epoxy-amine component.

The constituents of the Michael acceptor component are provided in Table 5.

TABLE 5
Michael acceptor component.

| Constituent | Material | Weight % |
|---|---|---|
| Miramer ® SC9610 | Melamine acrylate | 64 |
| Tetraglycidyl methylene dianiline | Multifunctional Epoxy | 32 |
| Cabosil ® TS-720 | Fumed Silica | 4 |

From Table 5, Miramer® SC9610, tetraglycidyl methylene dianiline, and Cabosil® TS-720 were added to a Max 300 L DAC cup and dispersed using a SpeedMixer®. The Michael acceptor component was transferred from the DAC cup to an Optimum® cartridge using a FlackTek SpeedDisc®, which was connected to one inlet of a ViscoTec 2K extruder mounted to a Lulzbot® Taz 6 3D printer gantry.

The constituents of the epoxy-amine component are provided in Table 6.

TABLE 6
Epoxy-amine component.

| Constituent | Material | Weight % |
|---|---|---|
| ¹ PPG amine adduct | Difunctional Polyamine | 88 |
| 1,8-Diazabicyclo[5.4.0]undec- | Tertiary amine catalyst | 8 |
| 7-ene | | |
| Cabosil ® TS-720 | Fumed silica | 4 |

¹ Polyamine adduct having a bisphenol F epoxy derived backbone; MW 1,000 Da.

From Table 6, the PPG amine adduct, 1,8-diazabicyclo[5.4.0]undec-7-ene, and Cabosil® TS-720 were added to a Max 300 L DAC cup and mixed using SpeedMixer®. The epoxy-amine component was transferred from the DAC cup to a separate Optimum® cartridge, which was connected to the other inlet of the ViscoTec 2k extruder mounted to a Lulzbot® Taz 6 3D printer gantry.

The components were combined and mixed by pumping the contents of the two cartridges through a static mixer to provide a multiple cure coreactive composition and extruded with Michael acceptor component to epoxy-amine component volume mix ratio of 1.6:1 and 3D printed into several objects including ASTM D638 Type IV dogbones for tensile tests. Dogbones consisting of 4 sequential overlying layers of the multiple cure coreactive composition were printed. The extrusion rate was approximately 3.0 mL/min and the average print head movement speed was about 2,400 mm/min. The gel time of the extruded multiple cure coreactive composition was measured to be approximately 300 sec.

The summary of the tensile properties for the dogbones is shown in Table 7 compared to a similar formulation without an epoxy-amine component.

TABLE 7
Summary of Tensile Properties for Example 3.

| | Young's | Tensile Strain | Tensile |
|---|---|---|---|
| Sample | Modulus (MPa) | at break (%) | Strength (MPa) |
| Multi-cure Example 3 | 1761 | 4.5 | 64 |
| Example 3 without | 1630 | 8 | 58 |
| epoxy-amine cure | | | |

### Example 4

### Aza-Michael Addition/Epoxy-Amine Multiple Cure Coreactive Composition

An aza-Michael addition/epoxy-amine multiple cure coreactive composition was prepared by combining a Michael acceptor component and an epoxy-amine component.

The constituents of the Michael acceptor components are provided in Table 8.

TABLE 8
Components of A-pack.

| Constituent | Material | Weight % |
|---|---|---|
| Miramer ® SC9610 | Melamine acrylate | 5.4 |
| Hexion Epon ™ 863 | Difunctional Epoxy | 90 |
| Cabosil ® TS-720 | Fumed Silica | 4.6 |

From Table 8, Miramer® SC9610, Hexion Epon™ 863, and Cabosil® TS-720 were added to a Max 300 L DAC cup and dispersed using a SpeedMixer®. The Michael acceptor component was transferred from the DAC cup to an Optimum® cartridge using a FlackTek SpeedDisc®, which was connected to one inlet of a ViscoTec 2K extruder mounted to a Lulzbot® Taz 6 3D printer gantry.

The constituents of the epoxy-amine component are provided in Table 9.

TABLE 9
Components of B-pack.

| Material | Component | Weight % |
|---|---|---|
| PPG amine adduct | Difunctional polyamine | 86 |
| Ancamine ® K54 | Lewis base catalyst | 10 |
| Cabosil ® TS-720 | Fumed silica | 4 |

From Table 9, the PPG amine adduct, Evonik Ancamine® K54, and Cabosil® TS-720 were added to a Max 300 L DAC cup and mixed using SpeedMixer®. The components were transferred from the DAC cup to a separate Optimum® cartridge, which was connected to the other inlet of a ViscoTec 2k extruder mounted to a Lulzbot® Taz 6 3D printer gantry.

The components were combined and mixed by pumping the contents of the two cartridges through a static mixer to provide a coreactive composition and extruded with an A-pack to B-pack volume mix ratio of 1.7:1 and 3D printed into several objects including ASTM D638 Type IV dogbones for tensile testing. Dogbones consisting of 4 sequential overlying layers of the coreactive composition were printed. The extrusion rate was approximately 3.0 mL/min and the average print head movement speed was about 2,400 mm/min. The gel time of the extruded coreactive composition was measured to be approximately 300 sec.

A summary of the tensile properties of the dogbones is provided in Table 10 and is compared to a similar formulation without the aza-Michael addition component.

TABLE 10
Summary of Tensile Properties for Example 4.

| | Young's | Tensile Strain | Tensile |
|---|---|---|---|
| Sample | Modulus (MPa) | at break (%) | Strength (MPa) |
| Multi-cure Example 4 | 1337 | 3 | 25 |
| Example 4 without | 1766 | 3 | 36 |
| aza-Michael addition | | | |
| cure | | | |

Finally, it should be noted that there are alternative ways of implementing the embodiments disclosed herein. Accordingly, the present embodiments are to be considered as illustrative and not restrictive. Furthermore, the claims are not to be limited to the details given herein and are entitled to their full scope and equivalents thereof.

1. A multiple cure coreactive composition comprising:
a polythiol;
a reactive polyamine; and
a coreactive compound, wherein the coreactive compound is reactive with the polythiol and with the reactive polyamine.

2. The multiple cure coreactive composition of claim 1, wherein the coreactive compound comprises a polyfunctional Michael acceptor, a polyepoxide, a polyisocyanate, or a combination of any of the foregoing.

3. The multiple cure coreactive composition of claim 1, wherein the composition does not comprise an independent catalyst for catalyzing the reaction between the polythiol and the coreactive compound and a catalyst for catalyzing a reaction between the polyamine and the coreactive compound.

4. The multiple cure coreactive composition of claim 1, wherein a ratio of the reaction rate between the polythiol and the coreactive compound to the reaction rate between the polyamine and the coreactive compound is greater than 2.

5. (canceled)

6. The multiple cure coreactive composition of claim 1, wherein the coreactive compound comprises a polyfunctional Michael acceptor.

7-15. (canceled)

16. The multiple cure coreactive composition of claim 1, wherein,
a reaction between the polythiol and the coreactive compound is characterized by a first gel time at a temperature of 25° C.;
a reaction between the reactive polyamine and the coreactive compound is characterized by a second gel time at a temperature of 25° C.; and
the ratio of the first gel time to the second gel time is greater than 2.

17-22. (canceled)

23. A multiple cure coreactive composition comprising:
a reactive polyamine;
a polyfunctional Michael acceptor;
a polyepoxide; and
a non-reactive catalyst for catalyzing the reaction between the reactive polyamine and the polyfunctional Michael acceptor or a non-reactive catalyst for catalyzing the reaction between the polyamine and the polyepoxide.

24. The multiple cure coreactive composition of claim 23, wherein the non-reactive catalyst is selected from a tertiary amine and a Lewis base.

25. The multiple cure coreactive composition of claim 23, wherein the reactive polyamine comprises a primary amine, a secondary amine, or a combination thereof.

26-30. (canceled)

31. The multiple cure coreactive composition of claim 23, wherein,
a reaction between the reactive polyamine and the Michael acceptor is characterized by a first gel time at a temperature of 25° C.;
a reaction between the reactive polyamine and polyepoxide is characterized by a second gel time at a temperature of 25° C.; and
the ratio of the first gel time to the second gel time is greater than 2.

32. The multiple cure coreactive composition of claim 23, wherein,
a reaction between the reactive polyamine and the Michael acceptor is characterized by a first gel time at a temperature of 25° C.;
a reaction between the reactive polyamine and polyepoxide is characterized by a second gel time at a temperature of 25° C.; and
the ratio of the second gel time to the first gel time is greater than 2.

33-35. (canceled)

36. A multiple cure coreactive composition comprising:
a reactive polyamine;
a polyfunctional Michael acceptor, a polyepoxide, or a combination thereof; and
an amine-reactive compound.

37. The multiple cure coreactive composition of claim 36, wherein the amine-reactive compound comprises a polyanhydride, a polyfunctional cyclic carbonate, a polyacetoacetate, or a combination of any of the foregoing.

38. The multiple cure coreactive composition of claim 36, wherein the reactive polyamine comprises a primary amine, a secondary amine, or a combination thereof.

39-43. (canceled)

44. The multiple cure coreactive composition of claim 36, wherein,
a reaction between the reactive polyamine and the amine-reactive compound is characterized by a first gel time at a temperature of 25° C.;
a reaction between the reactive polyamine and the polyfunctional Michael acceptor and/or polyepoxide is characterized by a second gel time at a temperature of 25° C.; and
the ratio of the first gel time to the second gel time is greater than 2.

45-48. (canceled)

49. The multiple cure coreactive composition of claim 36, wherein the multiple cure coreactive composition comprises an amine catalyst.

50-51. (canceled)

52. A cured composition prepared from the multiple cure coreactive composition of claim 1.

53. An object fabricated using the multiple cure coreactive composition of claim 1.

54. The object of claim 53, wherein the object is selected from a vehicle part, a seal cap, a sealing component, and a shoe sole.

55-57. (canceled)

58. The object of claim 57, wherein the vehicle part is an automotive vehicle art or an aerospace vehicle part.

59. A method of fabricating an object comprising extruding the multiple cure coreactive composition of claim 1.

60-62. (canceled)

63. The method of claim 59, wherein extruding comprises three-dimensional printing.
